(19) United States
(12) Patent Application Publication
(10) Pub. No.: US 2005/0131885 A1
(43) Pub. Date: Jun. 16, 2005

(54) Information processing apparatus and method, and program

(76) Inventors: Jun Komatsu, Kanagawa (JP); Yasuaki Yamagishi, Kanagawa (JP)

Correspondence Address: FROMMER LAWRENCE & HAUG LLP, 745 FIFTH AVENUE, NEW YORK, NY, 10151, US

(21) Appl. No.: 11/008,557

(22) Filed: Dec. 9, 2004

(30) Foreign Application Priority Data
Dec. 12, 2003 (JP) P2003-414233

(51) Int. Cl. G06F 7/00

(52) U.S. Cl. 707/3

(57) ABSTRACT

A content aggregator generates a new package containing a content item provided by a content provider and a content item provided by another content provider and also generates corresponding package metadata based on access control information generated by the two content providers. The content aggregator then provides (sells) the content items in the new package, which is different from the original packages, to a user based on the new package metadata. The present invention is applicable to an information processing system that can support a business method model in content providing services.

### BACKGROUND OF THE INVENTION

1. Field of the Invention

The present invention relates to information processing apparatuses and methods, and programs, and more particularly, to an information processing apparatus and method in which the forms and conditions for providing content can be freely changed within the conditions licensed by content supplier sources. The invention also relates to a program implementing the above-described method.

2. Description of the Related Art

Services for providing content are coming into widespread use. For example, Japanese Unexamined Patent Application Publication No. 2003-61066 discloses content providing services for providing music (audio information), that is, audio information providing services.

FIG. 1 illustrates the configuration implementing a known model of a business method for providing such services.

In FIG. 1, a user 1 is connected to each of content providers 2A through 2C via the Internet (not shown).

The user 1 obtains (purchases) content distributed from the content providers 2A through 2C in units of packages. That is, the content providers 2A through 2C provide (sell) content that can be distributed via the Internet to the user 1 in units of packages. The package is a unit for selling (purchasing) content as products. Accordingly, the package contains at least one item of content.

More specifically, the content provider 2A generates and provides a package 11A containing content 12A. Similarly, the content providers 2B and 2C generate and provide a package 11B containing content 12B and a package 11C containing content 12C, respectively.

In this case, the user 1 determines whether he/she purchases the packages 11A through 11C based on package metadata 13A through 13C associated with the packages 11A through 11C, respectively, and content metadata 14A through 14C associated with the content items 12A through 12C, respectively.

More specifically, a user terminal (not shown) of the user 1 recognizes by referring to the package metadata 13A and the content metadata 14A that the package 11A contains the content 12A solely (the package type is “unit” consisting of one item of content) whose title is “drama A—episode 2” and that the viewing period and the price of the package 11A are 7 days and 300 yen, respectively. The user terminal then provides the recognition result to the user.

The user can understand that he/she can purchase from the content provider 2A the content 12A (package 11A) having a title of “drama A—episode 2” that can be viewed for 7 days at the price of 300 yen, and determines whether to purchase the package 11A.

Similarly, the user terminal of the user 1 recognizes by referring to the package metadata 13B and content metadata 14-B that the package 11B contains the content 12B solely (the package type is “unit”) having a title of “drama B—episode 9” and that the viewing period and the price are 7 days and 500 yen, respectively. The user terminal then provides the recognition result to the user.

Then, the user can understand that he/she can purchase from the content provider 2B the content 12B (package 11B) having a title of “drama B—episode 9” that can be viewed for 7 days at the price of 500 yen, and determines whether to purchase the package 11B.

The user terminal of the user 1 also recognizes by referring to the package metadata 13C and content metadata 14C that the package 11C contains the content 12C solely (the package type is “unit”) having a title of “film C” and that the viewing period and the price are one month and 800 yen, respectively. The user terminal then provides the recognition result to the user.

Then, the user can understand that he/she can purchase from the content provider 2C the content 12C (package 11C) having a title of “film C” that can be viewed for one month at the price of 800 yen, and determines whether to purchase the package 11C.

As described above, the user 1 has to purchase from the content providers 2A through 2C the content items 12A through 12C under the conditions (for example, the above-described type, viewing period, and price) provided by the content providers 2A through 2C, respectively.

In other words, it is difficult for entities other than the content providers 2A through 2C to provide the content items 12A through 12C in the forms other than the packages 11A through 11C (other than the forms generated by the content providers 2A through 2C) or under the conditions other than the conditions (i.e., conditions indicated in the package metadata 13A through 13C) provided by the content providers 2A through 2C.

Because of this drawback, it is difficult to apply the following model of the business method to the field of the content providing services. That is, it is difficult to apply a business method model in which intermediary agents (secondary providers) repackage a plurality of products provided by different original providers (primary providers) and sell new packages.

More specifically, for example, in FIG. 1, as stated above, the content items 12A through 12C are provided from the content providers (primary providers) 2A through 2C in the form of the packages 11A through 11C, respectively. Since the type of each of the packages 11A through 11C indicates “unit”, an intermediary agent (secondary provider) (not shown) can repackage none of the content items 12A through 12C.

Even if the type of each of the packages 11A through 11C is “package” (consisting of two or more items of content), the other providing conditions (for example, the price and the viewing period) are fixed. Accordingly, even if the content items 12A through 12C are repackaged, the providing conditions of the new package are a mere combination of those of the original packages 11A through 11C. More specifically, for example, the price of the new package is the total of the original prices of the content items 12A through 12C (packages 11A through 11C), i.e., 1600 yen. The viewing period becomes inconsistent in the package; for example, the viewing period of the content item 12-C is one month, while that of the content items 12A and 12B is 7 days.

The secondary providers include not only intermediary agents for reselling content (repackaging content and selling new packages), but also various other agents, for example, agents for selling products other than content by associating services for selling those products with content providing services, and agents for providing content billing services.

The providing conditions include not only the above-described price and viewing period, but also the quality of the content (Quality of services (QoS)) (image quality, audio quality, and communication quality), and recommendations and conversion services of codec (cross encoding services) that match user terminals.

In the above-described publication (Japanese Unexamined Patent Application Publication No. 2003-61066), a method for providing audio content (plural of music pieces) matching user's favorites in an audio information providing system is disclosed. More specifically, in this method, when the user specifies user's favorites by selecting desired music genres and images of music and also specifies a desired price range, he/she can purchase a plurality of music pieces matching the user's favorites and price range.

The above publication, however, merely discloses that the price of each of the plurality of music pieces is weighted according to the user's favorites, and it is determined whether to purchase the music pieces by comparing the total cost of the weighted prices with the price range desired by the user. After all, the user has to purchase the music pieces at the price asked by the supply source (sales source).

The above publication does not assume business method models (for example, the above-described business method model with secondary intermediaries) other than the business method model disclosed in FIG. 1. Accordingly, the above publication does not disclose or suggest business methods other than the business method disclosed in FIG. 1, nor does it disclose that content is provided in units of packages, as in the configuration shown in FIG. 1.

Accordingly, the invention disclosed in this publication also suffers from the above-described problem unique to the known art in which the user has to purchase the content in the form and conditions determined (fixed) by content supplier sources.

### SUMMARY OF THE INVENTION

Accordingly, in view of the above background, it is an object of the present invention to freely change forms and conditions for providing content within the conditions licensed by a supplier source (first provider).

The present invention provides an information processing apparatus for generating a second package containing at least one content item selected from content items contained in a first package provided by a second information processing apparatus. The information processing apparatus includes: a storage unit for obtaining first metadata corresponding to the first package from the second information processing apparatus and storing the obtained first metadata therein, the first metadata including control information concerning conditions for generating the second package; a package generator for generating the second package containing at least one content item selected from the content items contained in the first package based on the control information contained in the first metadata stored in the storage unit; and a metadata generator for generating second metadata corresponding to the second package generated or to be generated by the package generator based on the control information.

The control information may include information concerning licensed elements that are allowed to be changed among elements forming the first metadata.

The control information may further include information concerning the type of operation to change each of the licensed elements.

The control information may further include information concerning a licensing condition for changing each of the licensed elements.

The control information may further include information concerning a device or an administrator for the device that is authorized to change each of the licensed elements.

The control information may further include information concerning content items that are allowed to be contained in the second package and selected from the content items of the first package.

The present invention also provides an information processing method for an information processing apparatus for generating a second package containing at least one content item selected from content items contained in a first package provided by a second information processing apparatus. The information processing method includes: a storage step of obtaining first metadata corresponding to the first package from the second information processing apparatus and storing the obtained first metadata therein, the first metadata including control information concerning conditions for generating the second package; a package generating step of generating the second package containing at least one content item selected from the content items contained in the first package based on the control information contained in the first metadata stored in the storage step; and a metadata generating step of generating second metadata corresponding to the second package generated or to be generated in the package generating step based on the control information.

The present invention also provides a program for allowing a computer to execute processing for generating a second package containing at least one content item selected from content items contained in a first package provided by a second information processing apparatus. The program includes: a storage step of obtaining first metadata corresponding to the first package from the second information processing apparatus and storing the obtained first metadata therein, the first metadata including control information concerning conditions for generating the second package; a package generating step of generating the second package containing at least one content item selected from the content items contained in the first package based on the control information contained in the first metadata stored in the storage step; and a metadata generating step of generating second metadata corresponding to the second package generated or to be generated in the package generating step based on the control information.

According to the information processing apparatus and method, and the program of the present invention, a second package containing at least one content item selected from content items contained in a first package provided by a second information processing apparatus is generated. More specifically, first metadata corresponding to the first package containing control information concerning a condition for generating the second package is obtained from the second information processing apparatus and is stored. Based on this control information, the second package containing at least one content item selected from the content items contained in the first package is generated, and the corresponding second metadata is also generated.

As is seen from the foregoing description, according to the present invention, content can be provided in units of packages. In particular, forms and conditions for providing content can be freely changed within the conditions licensed by a supplier source.

### BRIEF DESCRIPTION OF THE DRAWINGS

FIG. 1 illustrates a known model of a business method in content providing services;

FIG. 2 illustrates a model of a business method in content providing services supported by an information processing system (information processing apparatus) according to an embodiment the present invention;

FIG. 3 illustrates an example of sales promotions conducted by a content aggregator for the user in the model shown in FIG. 2;

FIG. 4 illustrates another model of the business method in content providing services supported by the information processing system (information processing apparatus) of the present invention;

FIG. 5 illustrates an example of sales promotions conducted by a content aggregator for the user in the model shown in FIG. 4;

FIG. 6 illustrates another model of the business method in content providing services supported by the information processing system (information processing apparatus) of the present invention;

FIG. 7 illustrates an example of sales promotions conducted by a content aggregator for the user in the model shown in FIG. 6;

FIG. 8 is a block diagram illustrating the configuration of the information processing system of the present invention;

FIG. 9 is a block diagram illustrating the configuration of a content provider server in the information processing system shown in FIG. 8;

FIG. 10 is a block diagram illustrating the configuration of a content aggregator server in the information processing system shown in FIG. 8;

FIG. 11 illustrates relationships between various IDs and metadata;

FIG. 12 illustrates relationships between package metadata, license metadata, and content metadata;

FIG. 13 illustrates an example of the configuration of the package metadata used in the information processing system shown in FIG. 8;

FIG. 14 illustrates an example of the configuration of the access control information used in the information processing system shown in FIG. 8;

FIG. 15 illustrates licensed elements and unlicensed elements contained in the access control information shown in FIG. 14;

FIG. 16 is a flowchart illustrating package regenerating processing executed by the content aggregator server shown in FIG. 10;

FIG. 17 illustrates a model of a business method in content providing services supported by an information processing system (information processing apparatus) according to another embodiment the present invention; and

FIG. 18 is a block diagram illustrating an example of the hardware configuration of the information processing system of the present invention.

### DESCRIPTION OF THE PREFERRED EMBODIMENTS

The present invention is described below with reference to the accompanying drawings through illustration of preferred embodiments.

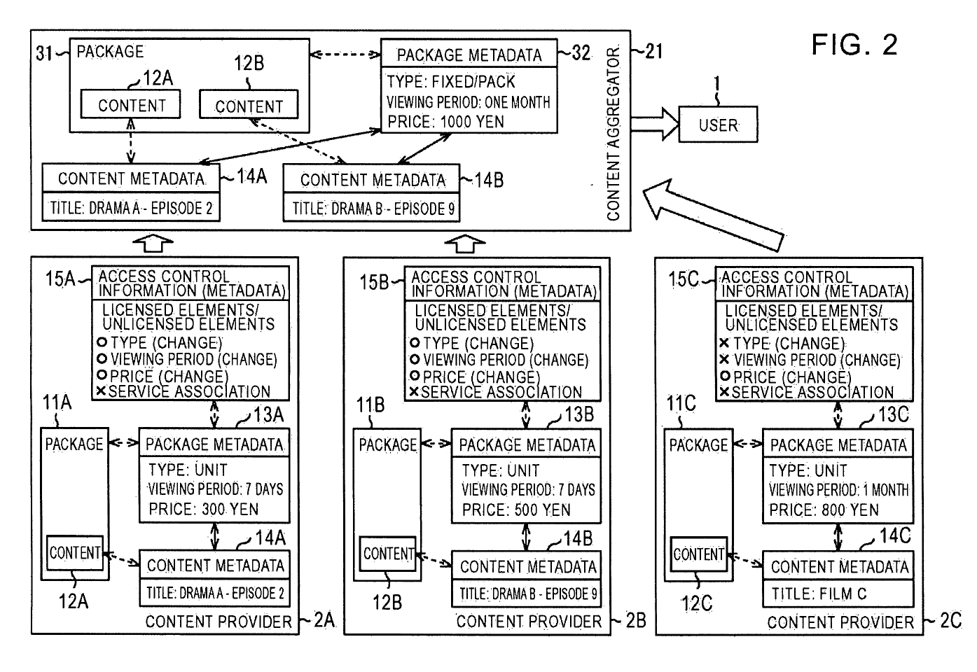

A description is first given, with reference to FIGS. 2 through 7, of a business method model supported by an information processing system to which the present invention is applied.

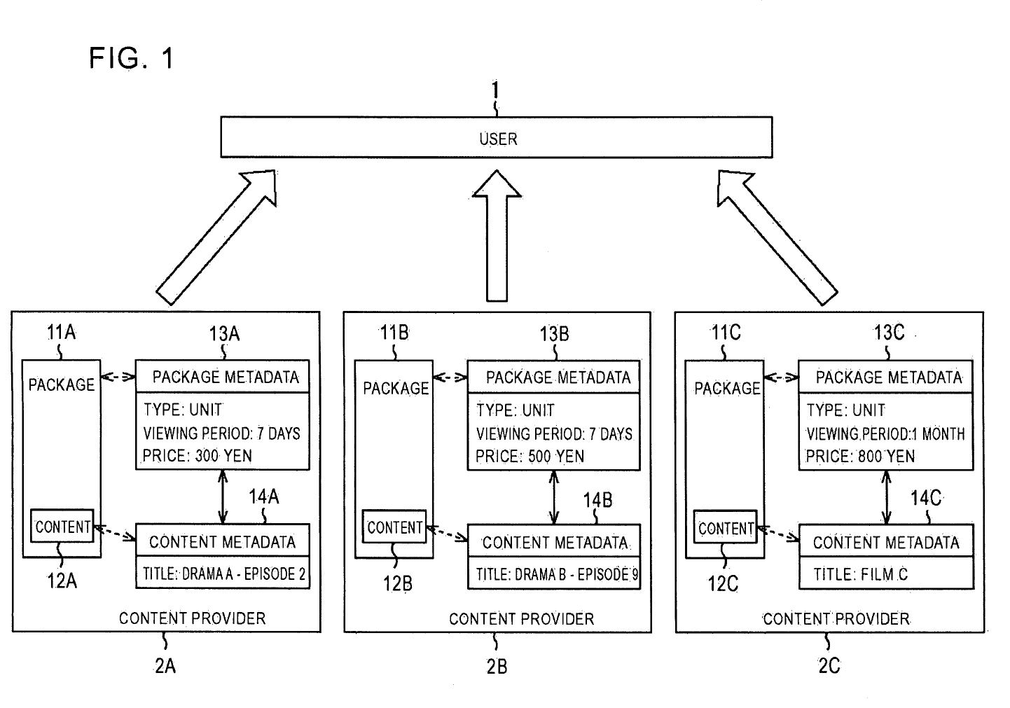

FIG. 2 illustrates the configuration of such a business method model. In FIG. 2, elements corresponding to those in FIG. 1 are designated with like reference numerals. As described below, the information processing system of the present invention can support various business method models, and the configuration of the model shown in FIG. 2 can solve the problem unique to the known model of the business method shown in FIG. 1.

In the model shown in FIG. 2, a certain number of users (one user 1 in FIG. 2), a certain number of content providers (three content providers 2A through 2C in FIG. 2), and a certain number of content aggregators (one content aggregator 21 in FIG. 2) can be participated.

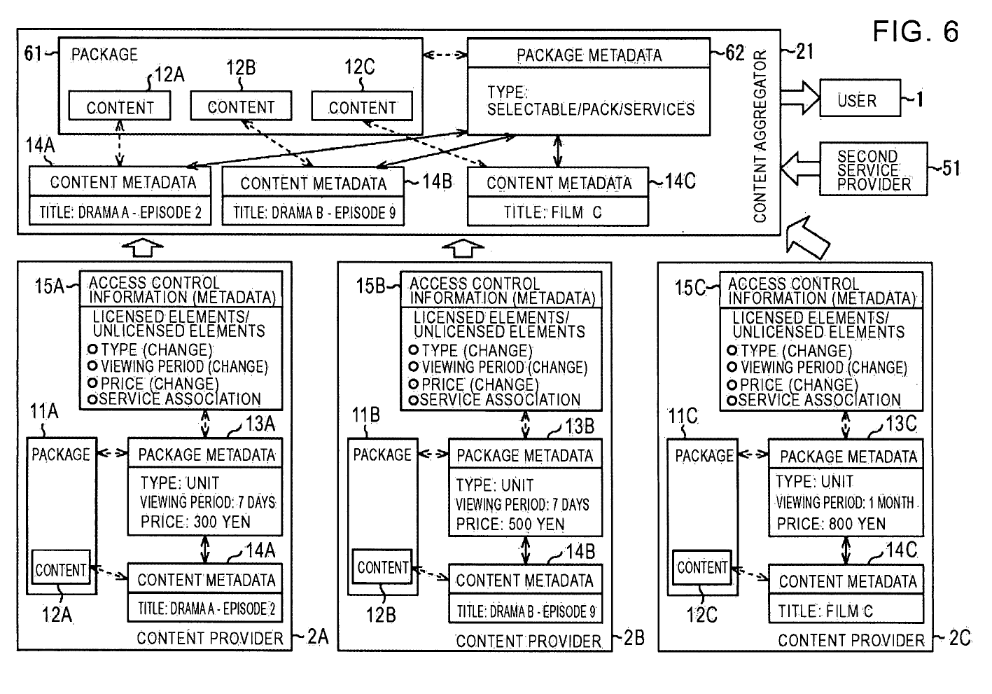

Additionally, as stated below with reference to FIG. 6, a certain number of other service providers (second service provider 51 in FIG. 6) may be participated in this business method model.

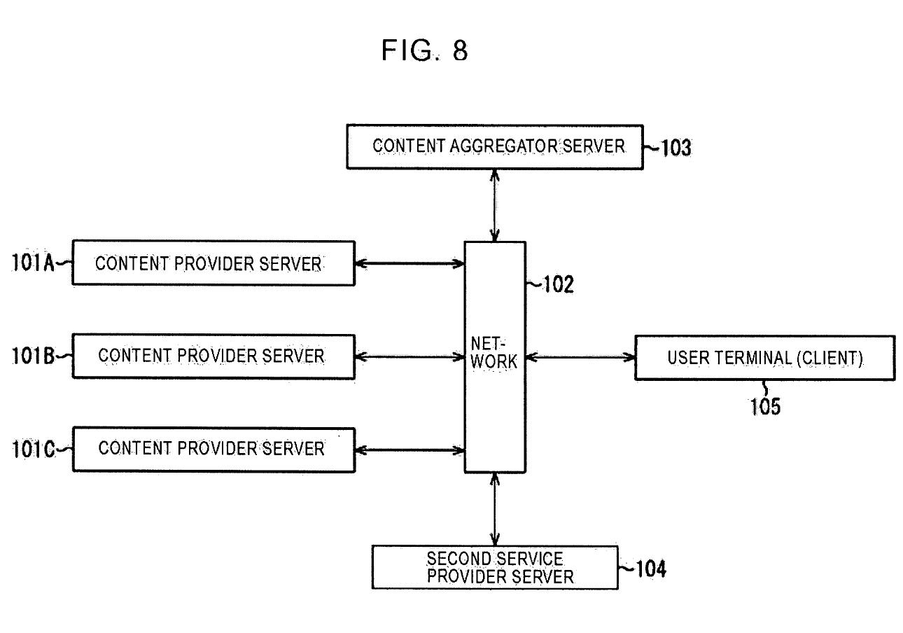

The user 1 controls a user terminal (client) 105, such as the one shown in FIG. 8, which can be connected to a network 102, and obtains (purchases) content by using this user terminal 105.

The content providers 2A through 2C control content provider servers 101A through 101C, respectively, such as those shown in FIG. 8, which can be connected to the network 102, and provide (sell) content by using the content provider servers 101A through 101C, respectively.

That is, the content providers 2A through 2C are primary providers for providing content. In this specification, the primary provider is the one who first sets conditions for providing (selling) content, that is, the one who first creates content metadata.

On the other hand, the secondary provider is the one who provides (resells) content provided by the primary provider to other entities as the product of the secondary provider. In the example shown in FIG. 2, the content aggregator 21 is the secondary provider.

More specifically, the content aggregator 21 is an entity authorized to commercially sell content by the primary provider. For example, the content aggregator 21 controls a content aggregator server 103, such as the one shown in FIG. 8, which can be connected to the network 102, and repackages at least one content item provided by the primary provider and sells the new package by using the content aggregator server 103.

The second service provider 51 is discussed later with reference to FIG. 6.

One example of the flow in the business method model is discussed below with reference to FIG. 2.

The actual processing is performed by the elements shown in FIG. 8 (content provider servers 101A through 101C, a content aggregator server 103, a second service provider server 104, and a user terminal 105). A description is given below, however, assuming that the participants, i.e., the user 1, the content providers 2A through 2C, the content aggregator 21, and the second service provider 51 shown in FIG. 6, of this business method model execute the processing.

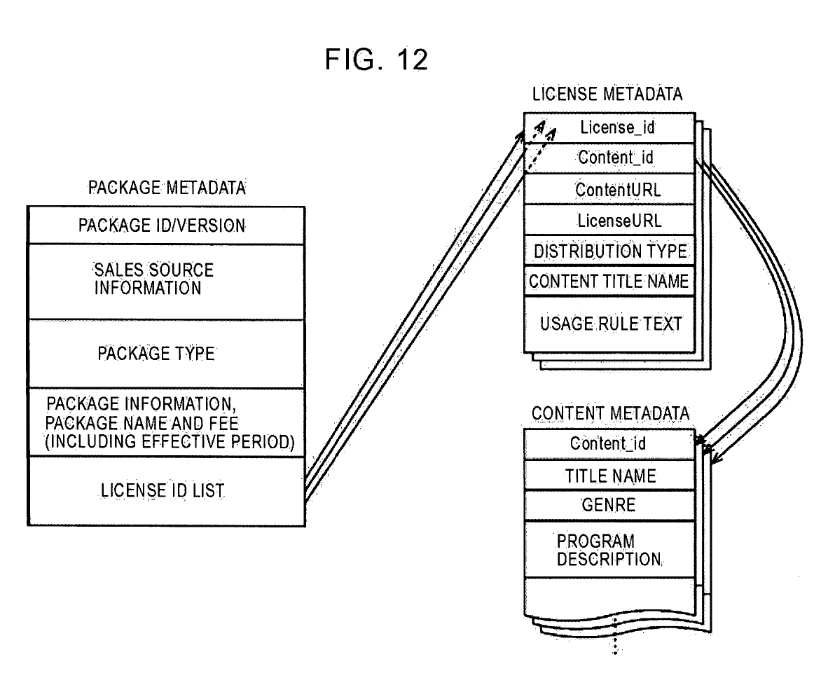

The content provider 2A first generates content 12A and corresponding content metadata 14A. In the example shown in FIG. 2, the title of the content metadata 14A is “drama A—episode 2”. The other descriptions of the content metadata 14-A are discussed below with reference to FIG. 12.

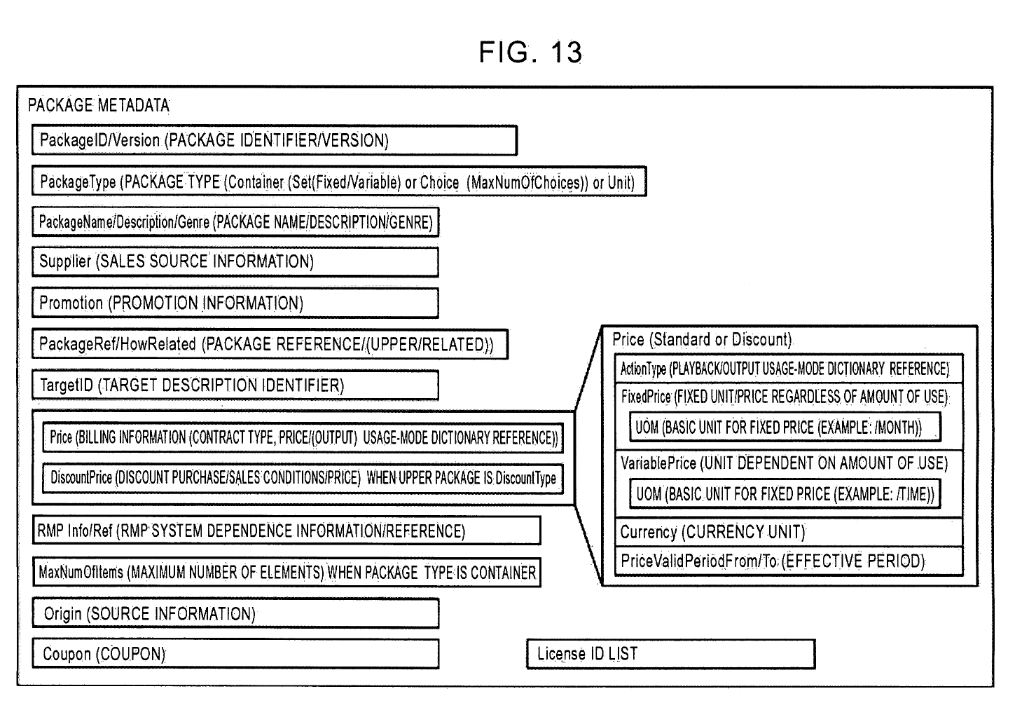

Then, the content provider 2A generates a package 11A containing at least the content 12A (only one content 12A in the example in FIG. 2) and corresponding package metadata 13A. In the package metadata 13A, the type is set to be “unit” (consisting of only one item of content) and the viewing period and the price are 7 days and 300 yen, respectively. The other descriptions of the package metadata 13A are discussed below with reference to FIGS. 12 and 13.

As stated above, according to the related art, it is difficult for other entities, such as the content aggregator 21, to provide the content 12A in the forms other than the package 11A (other than the form generated by the content provider 2A) or under the conditions other than the predetermined conditions (other than the descriptions in the package metadata 13A generated by the content provider 2A).

To solve this problem, the assignee of the present application has invented a method for allowing an entity, for example, the content aggregator 21, to change the package metadata 13A. In this method, however, the package metadata 13A may be altered without the permission of the content provider 2A, and thus, the benefit of the content provider 2A or the copyright of the content 12A may be violated.

To further solve this problem as well as the above-described problem, the assignee of the present application has invented the following method.

In this method, the content provider 2A generates access control information 15A, such as that shown in FIG. 2, corresponding to the package metadata 13A. Alternatively, the content provider 2A adds the access control information 15A as metadata for the package 11A (content 12A).

The access control information 15A is new concept (information) introduced in this embodiment. Details of the access control information 15A are given below.

The access control information 15A indicates conditions under which the content aggregator 21 generates a new package 31.

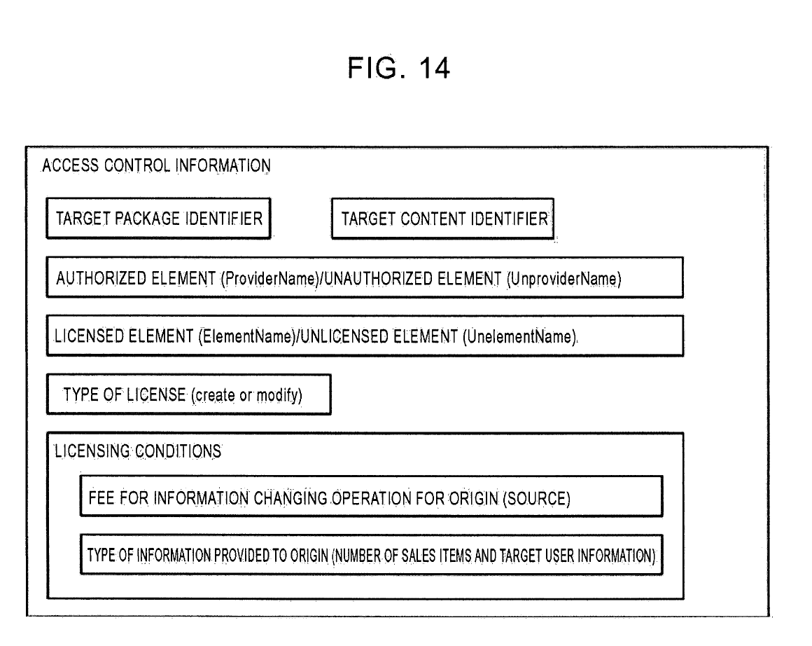

More specifically, in the access control information 15A, the elements forming the package metadata 13A (or also the elements forming the content metadata 14A if necessary) are divided into a fixed portion and a variable portion that can be changed later by being updated or added. Then, the access control information 15A indicates whether the elements forming the variable portion can be actually changed, in other words, whether the content provider 2A permits an entity, such as the content aggregator 21, to change the elements forming the variable portion. More precisely, the access control information 15A may further include other related items of information, such as those shown in FIG. 14.

In this case, generally, the fixed portion contains elements for uniquely identifying the content 12A corresponding to the content metadata 14A and the package 11A (content group) corresponding to the package metadata 13A.

In contrast, the variable portion contains elements indicating the content owner, supply source, service provider, accompanying information indicating the rights for the user, effective period, price, how to obtain content, and how to play back content.

In other words, the access control information 15A includes at least elements that can be changed (hereinafter referred to as “licensed elements”) by the content aggregator 21 among the elements forming the package metadata 13A (and content metadata 14A if necessary). The access control information 15A may further include elements that cannot be changed (hereinafter referred to as “unlicensed elements”) by the content aggregator 21.

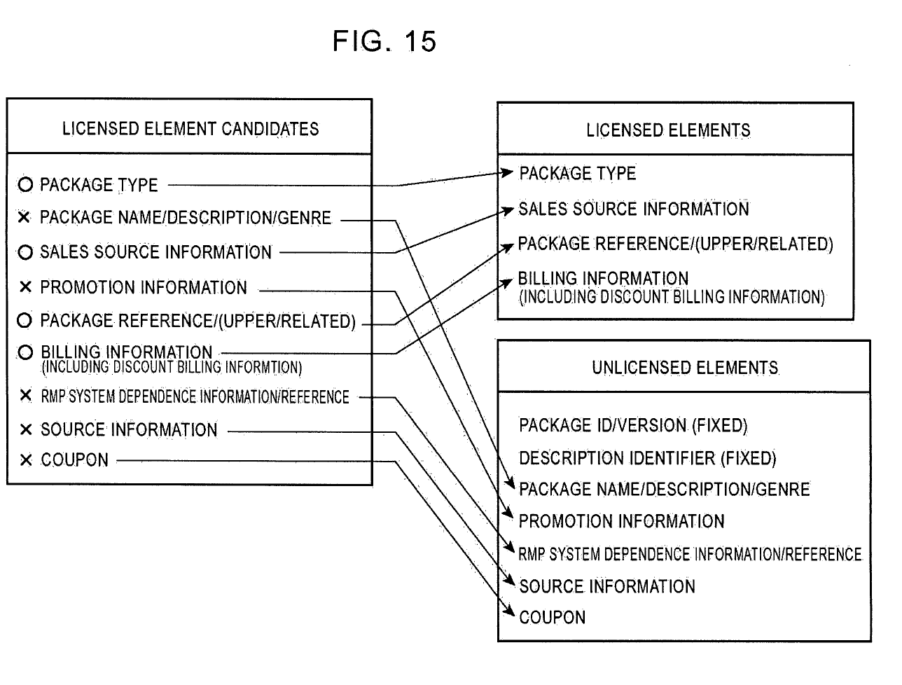

The licensed elements include elements which are selected from the elements forming the variable portion, such as those shown in FIG. 15 and which are allowed (licensed) to be changed by secondary providers by permission of the content provider 2A, such as those indicated by the circles in FIG. 15.

In contrast, the unlicensed elements include not only the elements forming the fixed portion, such as elements provided with the word “fixed” at the end in FIG. 15, but also elements that the content provider 2A does not permit the content aggregator 21 to change, such as those indicated by the cross (x) in FIG. 15, in the variable portion.

More specifically, in the access control information 15A shown in FIG. 2, “type (change)”, “viewing period (change)”, and “price (change)” are licensed elements. That is, a secondary provider, such as the content aggregator 21, is allowed (licensed) to change the “type”, “viewing period”, and “price” by permission of the content provider 2A.

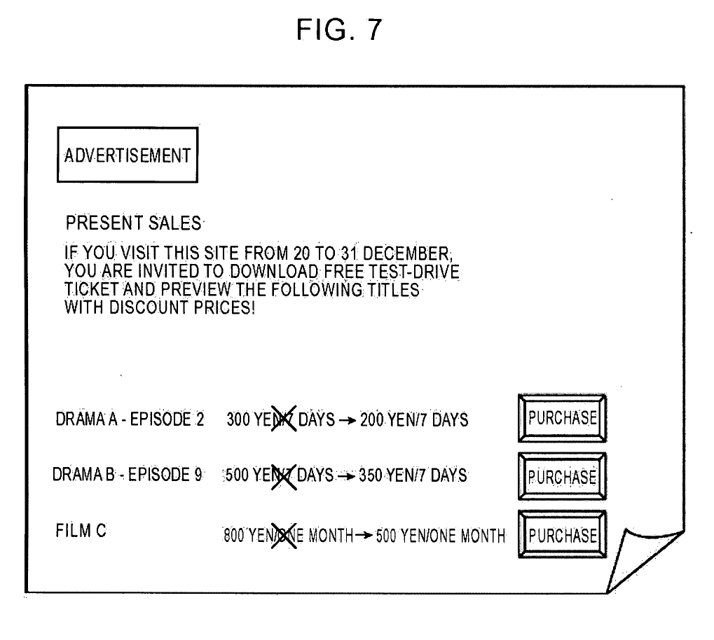

In contrast, in the access control information 15A shown in FIG. 2, “service association” is an unlicensed element. That is, in the example shown in FIG. 2, among the elements forming the package metadata 13A, the application of the “service association” is prohibited by the content provider 2A. Details of the “service association” are discussed later with reference to FIGS. 6 and 7.

As in the content provider 2A, when creating a package 11B containing content 12B, the content provider 2B also generates the corresponding package metadata 13B and access control information 15B. When creating a package 11C containing content 12C, the content provider 2C generates the corresponding package metadata 13C and access control information 15C.

In the example shown in FIG. 2, in the access control information 15B, the “type (change)”, “viewing period (change)”, and “price (change)” are licensed elements, and “service association” is an unlicensed element. That is, among the elements forming the package metadata 13B, changing of the “type”, “viewing period”, and “price” is licensed by the content provider 2B, while the application of the “service association” is not licensed by the content provider 2B.

In the access control information 15C, only the “price” is a licensed element, and the “type (change)”, “viewing period (change)”, and “service association (change)” are unlicensed elements. That is, among the elements forming the package metadata 13C, changing of only the “price” is licensed by the content provider 2C, and changing of the “type” and “viewing period” and the application of the “service association” are not licensed by the content provider 2C.

As discussed above, the content providers 2A through 2C each generate the access control information 15A through 15C, respectively, at their discretion so that they can give an instruction whether or not a secondary provider, such as the content aggregator 21 in FIG. 2, is allowed to change each of the elements forming the package metadata 13A through 13C (and the elements forming the content metadata 14A through 14C if necessary), respectively.

As stated above, various items of information other than the “licensed elements/unlicensed elements” may be contained in the access control information 15A through 15C according to the necessity. Specific examples of such items of information are discussed later with reference to FIG. 14.

The content aggregator 21 can generate a new package (repackages) containing at least one of the content items 12A through 12C based on the access control information 15A through 15C, and provides (sells) the new package to the user 1.

More specifically, in the example shown in FIG. 2, in the access control information 15C, the “type” is an unlicensed element that cannot be changed, and also, in the package metadata 13C, the “type” is set to be “unit”. Accordingly, the content 12C can be provided only in the package 11C as a unit. That is, the content aggregator 21 cannot repackage the content 12C.

Conversely, both in the access control information 15A and 15B, the “type” is set to be a licensed element that can be changed. Accordingly, the content items 12A and 12B can be provided as a package different from the packages 11A and 11B, respectively. That is, the content aggregator 21 can repackage the content item 12A or 12B and provides (sells) it to the user 1.

Also, both in the access control information 15A and 15B, the “viewing period” and “price” are licensed elements. Accordingly, when generating a new package (repackages) containing at least one of the content items 12A and 12B, the content aggregator 21 can freely set the price or the viewing period of the new package at its discretion, in other words, the content aggregator 21 can change the original price or viewing period.

More specifically, in the example shown in FIG. 2, the content aggregator 21 can generate the new package 31 containing both the content items 12A and 12B.

In this case, the content aggregator 21 can generate package metadata 32 by setting the “type” of the package 31 to be “fixed/pack” (changed from the “unit” set in the package 11A or 11B), the “viewing period” to “one month” (changed from “7 days” set in the package 11A or 11B), and the “price” to be “1000 yen” (changed from “300 yen” set in the package 11A or “500 yen” set in the package 11B). In the package metadata 32, the definition of “fixed” in the “type: fixed/pack” is described later.

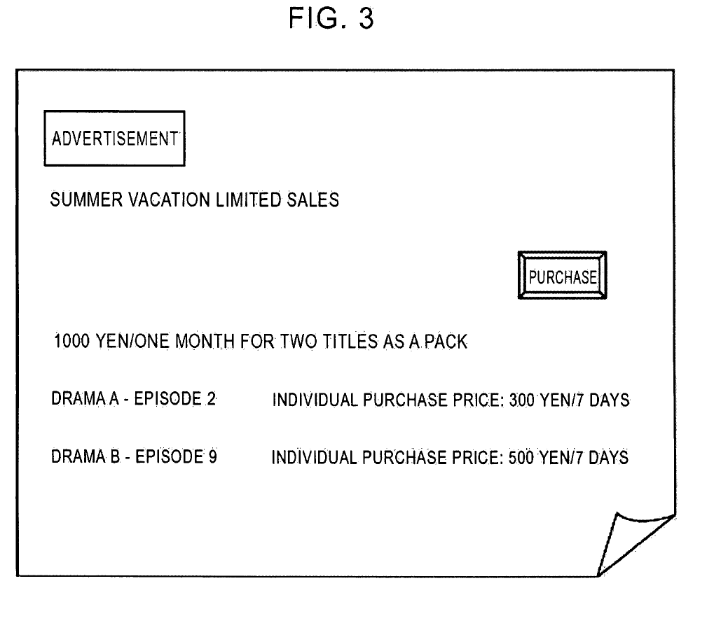

The content aggregator 21 then generates advertisement information, such as that shown in FIG. 3, based on the new package metadata 32 and content metadata 14A and 14B, and provides the information to the user 1.

FIG. 3 illustrates an example of the display format (image) when the user terminal 105 (FIG. 8) of the user 1 displays advertisement information on a display unit (not shown). In actuality, the content aggregator server 103 (FIG. 8) of the content aggregator 21 generates the advertisement information in the form of hyper text markup language (HTML) or broadcast markup language (BML) text corresponding to the image shown in FIG. 3, and sends it to the user terminal 105 of the user 1 via the network 102 (FIG. 8).

Then, the user terminal 105 of the user 1 interprets the advertisement information (HTML or BML text), converts it to the image shown in FIG. 3, and then provides it to the user 1.

When the user 1 wishes to purchase the package 31 by looking at the image shown in FIG. 3, he/she presses a purchase button (or by using a remote commander (not shown)) shown in FIG. 3 so as to obtain (purchase) the package 31 from the content aggregator 21.

Conventionally, the user 1 has to directly obtain (purchase) the content 12A whose title is “drama A—episode 2” from the content provider 2A under the providing conditions that the viewing period is 7 days and the price is 300 yen. The user 1 also has to directly obtain (purchase) the content 12B whose title is “drama B—episode 9” from the content provider 2B under the providing conditions that the viewing period is 7 days and the price is 500 yen.

Accordingly, if the user 1 wishes to view each of the content items 12A and 12B for 28 days (=7 days×4=about one month), he/she has to pay 1200 yen (=300×4) to the content provider 2A, and also has to pay 2000 yen (=500×4) to the content provider 2B. That is, the user must pay a total of 3200 yen.

In contrast, according to the present invention (business method model supported by the present invention), the user 1 can purchase both the content items 12A and 12B from the content aggregator 21 under the new providing conditions that the viewing period is one month and the price is 1000 yen.

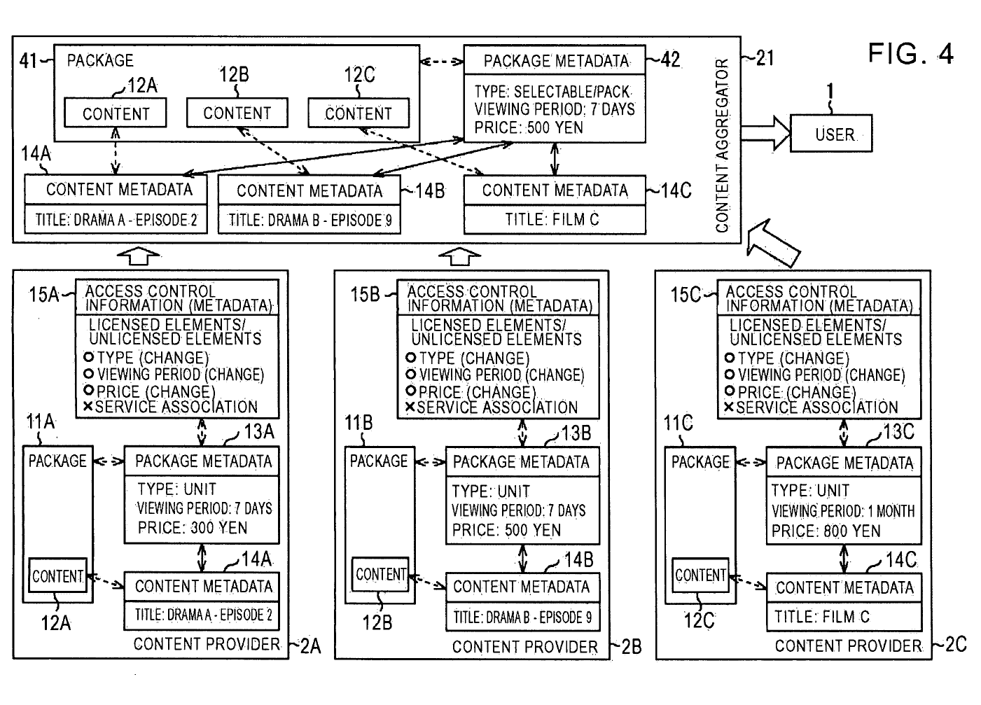

Another model of the business method is described below with reference to FIG. 4. In the model shown in FIG. 4, the content of the access control information 15A through 15C are different from that shown in FIG. 2. As a result, the content aggregator 21 generates a new package and corresponding package metadata different from those shown in FIG. 2 and sells the package to the user 1. In FIG. 4, elements corresponding to those in FIG. 2 are designated with like reference numerals.

As in FIG. 2, in FIG. 4, in both the access control information 15A and 15B, the “type (change)”, “viewing period (change)”, and “price (change)” are licensed elements, and the “service association” is an unlicensed element. Also in the access control information 15C, the “type (change)”, “viewing period (change)”, and “price (change)” are licensed elements, and the “service association” is an unlicensed element.

Accordingly, in the example shown in FIG. 4, in any of the package metadata 13A through 13C, all the elements “type”, “viewing period”, and “price” can be changed, in other words, changing of these elements is licensed by the content providers 2A through 2C, respectively.

Thus, for example, as shown in FIG. 4, the content aggregator 21 generates a new package 41 containing all the content items 2A through 2C, and more precisely, the package 41 containing two content items selected by the user 1 from the content items 12A through 12C, as described below.

In this case, the content aggregator 21 can generate new package metadata 42 by setting the “type” of the package 41 to be “selectable/pack” (changed from the “unit” set in the packages 11A through 11C), the “viewing period” to be 7 days (changed from one month set in the package 11C), and the “price” to be 500 yen (changed form 300 yen set in the package 11A or 800 yen set in the package 11C).

The difference between “fixed” and “selectable” of the “type” is as follows. The “fixed” means that content contained in a package is fixed. The “selectable” means that content items contained in a package can be selected by the user, i.e., a preset number of content items can be selected from a preset number of content items.

For example, in the package metadata 42, the type of the package 41 is “selectable/pack”. Accordingly, when the user 1 purchases the package 41, he/she can select a specified number (for example, two) of content items from the three content items 12A through 12C and thus purchases the package 41 containing the selected two content items from the content aggregator 21.

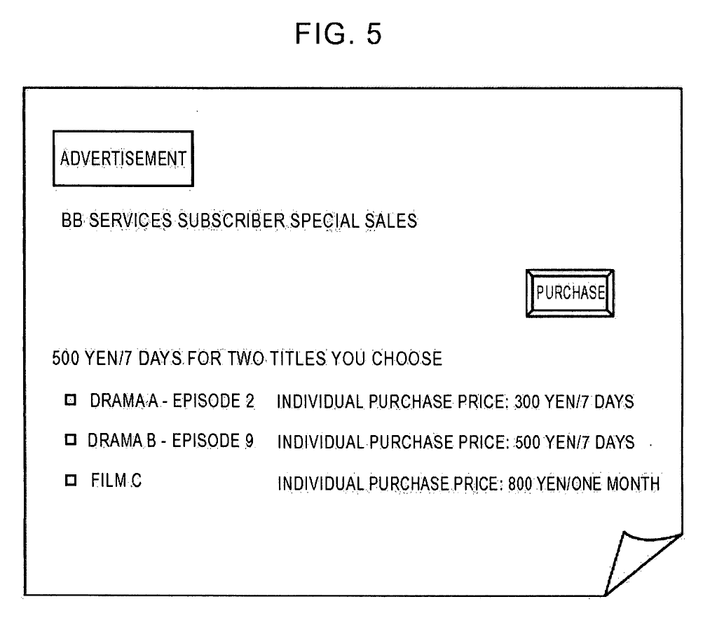

More specifically, the content aggregator 21 can generate advertisement information (HTML or BML text) corresponding to the image shown in FIG. 5 based on the package metadata 42 and the content metadata 14A through 14C, and provides the information to the user terminal 105 (FIG. 8) of the user 1.

Then, the user terminal 105 of the user 1 interprets the advertisement information, converts it into the image shown in FIG. 5, and provides it to the user 1.

If the user 1 wishes to purchase the package 41 by looking at the image shown in FIG. 5, he/she checks two boxes (or by using a remote commander) from the boxes indicated at the left of the titles (drama A—episode 2, drama B—episode 9, and film C) of the content items so as to select two content items to be contained in the package 41.

Then, by pressing the purchase button (or by using the remote commander), the user 1 can purchase the package 41 containing the selected (checked) two content items from the content aggregator 21.

More specifically, if the user 1 checks the boxes at the left of the drama A—episode 2 and the film C, the content items 12A and 12C are contained in the package 41.

Conventionally, the user 1 has to directly obtain (purchase) the content 12A whose title is “drama A—episode 2” from the content provider 2A under the providing conditions that the viewing period is 7 days and the price is 300 yen. The user 1 also has to directly obtain (purchase) the content 12C whose title is “film C”, from the content provider 2C under the providing conditions that the viewing period is one month and the price is 800 yen.

Accordingly, if the user 1 wishes to view each of the content items 12A and 12C for 7 days, he/she has to pay 300 yen to the content provider 2A and also has to pay 800 yen to the content provider 2C. That is, the user must pay a total of 1100 yen.

In contrast, according to the business method in this embodiment, the user 1 can purchase both the content items 12A and 12C from the content aggregator 21 under the new providing conditions that the viewing period is 7 days and the price is 500 yen.

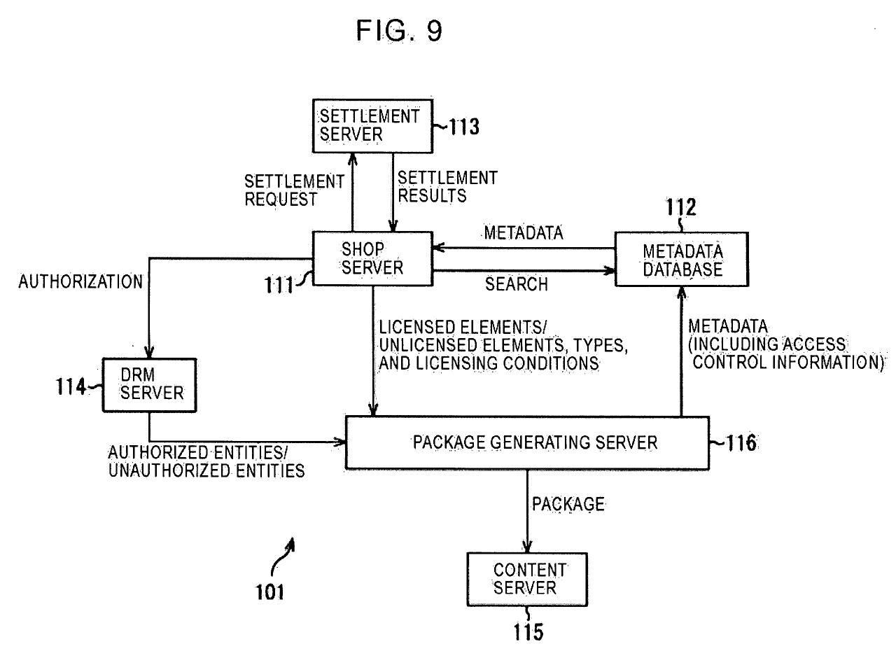

Additionally, conventionally, when selecting two items from the content items 12A through 12C, the user 1 has to contact each of the content providers 2A through 2C so as to obtain and compare the purchase conditions. In actuality, the user terminal 105 shown in FIG. 8 accesses a shop server 111, such as that shown in FIG. 9, managed by each of the content providers 2A through 2C, and compares web pages of the shop servers 111. This is troublesome and time-consuming.

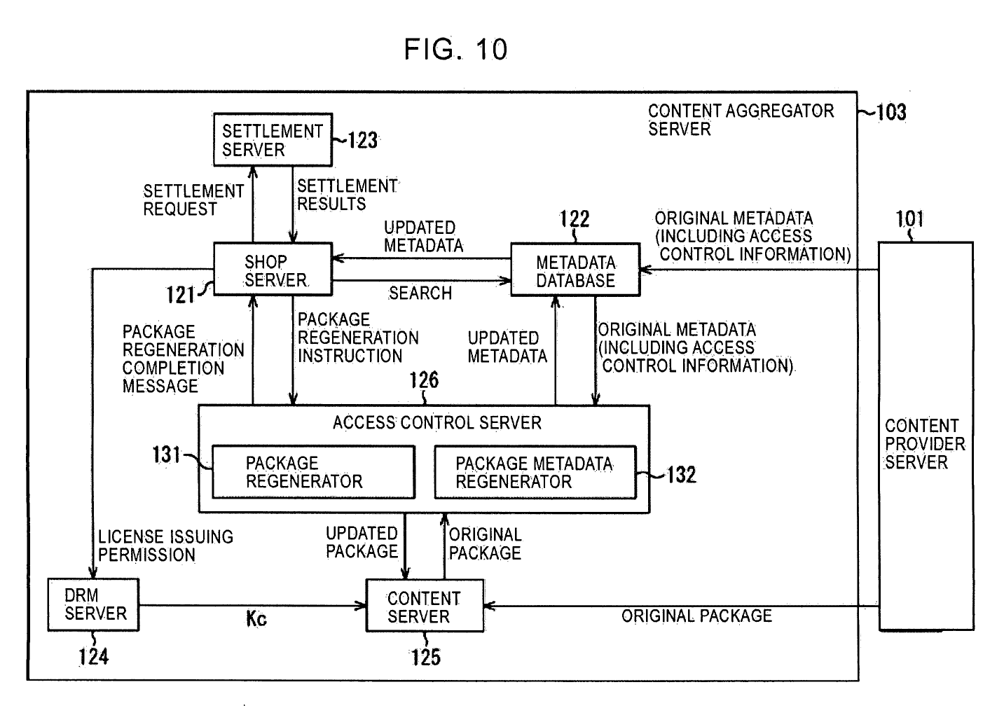

On the other hand, in the business method of the present embodiment, the user 1 can easily select and purchase two content items from the content items 12A through 12C merely by contacting the content aggregator 21 (in actuality, the user terminal 105 accesses a shop server 121 shown in FIG. 10 managed by the content aggregator 21) and by performing a simple operation, for example, by using the user interface image shown in FIG. 5.

Another model of the business method of the present invention, which is different from that shown in FIG. 2 or 4, is described below with reference to FIG. 6. The model shown in FIG. 6 is different from that shown in FIG. 2 or 4 in that the application of “service association”, which is an unlicensed element in FIG. 2 or 4, is implemented, that is, another service (second service) is associated with content providing services. In FIG. 6, elements corresponding to those in FIGS. 2 and 4 are designated with like reference numerals.

As in FIG. 4, in the example shown in FIG. 6, in all the access control information 15A through 15C, the “type (change)”, “viewing period (change)”, and “price (change)” are licensed elements. In FIG. 6, the “service association” is also a licensed element.

Accordingly, in the example shown in FIG. 6, in any of the package metadata 13A through 13C, the “type”, “viewing period”, and “price” can be changed, in other words, changing of these items is licensed by the content providers 2A through 2C.

The “service association” means that a certain package providing service can be associated with another service (second service). That is, if the “service association” is a licensed element, the corresponding package providing service can be associated with another service. In contrast if the “service association” is an unlicensed element, the corresponding package providing service cannot be associated with another service.

In the example shown in FIG. 6, in any of the access control information 15A through 15C, the “service association” is set to be a licensed element, the providing service of each of the packages 11A through 11C can be associated with another service. Additionally, in the access control information 15A through 15C, since the “type” is a licensed element, any of the content 12A through 12C can be contained in a new package (package 61 in FIG. 6) (repackaged). That is, the generation of a new package containing at least one of the content items 12A through 12C is licensed, as in FIG. 4, and the association of the new package with another service is also licensed.

The definition of the “second service” (another service) in this specification is as follows. In this specification, content includes not only general content, such as television broadcasting programs, films, photographs, music pieces (moving pictures, still images, sound, and a combination thereof), but also software or hardware that can be used (viewed or experienced) by users, such as promotions, documents, products (including goods), and conversation. To apply the present invention, however, metadata must be associated with content. Accordingly, in this specification, services for providing content that is associated with at least one metadata are referred to as “content providing services”, and other services are referred to as “second services”. That is, if a service is for providing content, it is handled as a “second service” unless the content provided by this service is associated with metadata.

Thus, in this specification, an entity for providing a second service defined as described above to the user 1 is referred to as a “second service provider”. As stated above, the second service provider can be a participant of a model in the business method of this embodiment. In the example shown in FIG. 6, one second service provider 51 participates in the model of this business method.

As discussed above, the content aggregator 21 can generate, as shown in FIG. 6, the new package 61 containing all the content items 12A through 12C, and more precisely, the package 61 containing two content items selected by the user 1 from the content items 12A through 12C.

In this case, the content aggregator 21 can generate new package metadata 62 by setting the “type” of the package 61 to be “selectable/pack/service association” (changed from the “unit” set in the packages 11A through 11C) and setting elements, such as “viewing period” and “price” (changed from the original elements set in the packages 11A through 11C).

Specific examples of the “viewing period” and “price” are not indicated in the package metadata 62 shown in FIG. 62 because they are different according to the content items contained in the package 61, as shown in FIG. 7.

Then, the content aggregator 21 can generate advertisement information indicating that the content providing service of the new package 61 is associated with a second service provided by the second service provider 51. More specifically, the content aggregator 21 can generate advertisement information (HTML or BML text) corresponding to the image shown in FIG. 7 based on the new package metadata 62 and the content metadata 14A through 14C, and provides the advertisement information to the user terminal 105 (FIG. 8) of the user 1.

Then, the user terminal 105 of the user 1 interprets this advertisement information, converts it into the image shown in FIG. 7, and provides it to the user 1.

By looking at the image shown in FIG. 7 and also visiting a car site (not shown), the user 1 can obtain a free test-drive ticket and also obtain (purchase) the content 12A having a title of “drama A—episode 2”, the content 12B having a title of “drama B—episode 9”, and the content 12C having a title of “film C” at a discount price.

If the user 1 wishes to obtain a free test-drive ticket, he/she can obtain it by contacting the second service provider 51 and by performing required processing. In actuality, the user terminal 105 can download data indicating the test-drive ticket by accessing the second service provider server 104 shown in FIG. 8 managed by the second service provider 51 and by performing the required processing.

As stated above, the test-drive ticket can be handled as the content defined in this specification because it can be used by the user. However, since metadata is not associated with the text-drive ticket, the text-drive ticket providing service (download service) is treated as a second service.

If the user 1 wishes to obtain content (at least one of the content items 12A through 12C), he/she can purchase the package 61 from the content aggregator 21 by pressing two purchase buttons (or using a remote commander) corresponding to desired content items selected from the purchase buttons indicated at the right of the content information (“drama A—episode 2 300 yen/7 days→200 yen/7 days”, “drama B—episode 9 500 yen/7 days→350 yen/7 days”, and “film C 800 yen/one month→500 yen/one month”).

More specifically, if the user 1 presses the purchase buttons indicated at the right of “drama A—episode 2 300 yen/7 days→200 yen/7 days” and “film C 800 yen/one month→500 yen/one month”, he/she can purchase the package 61 containing the content 12A and the package 61 containing the content 12C (or the package 61 containing the content items 12A and 12C) from the content aggregator 21.

In this case, the package metadata 62 corresponding to the package 61 containing the content 12A indicates that the “viewing period” is 7 days and the “price” is 200 yen. The package metadata 62 corresponding to the package 61 containing the content 12C indicates that “viewing period” is one month and the “price” is 500 yen.

As discussed above, in the business method of the present invention, content providing services can be easily associated with second services, which has been difficult in a known business method (FIG. 1).

In the models of the business method described with reference to FIGS. 2 through 7, the content aggregator 21 (secondary provider) repackages a plurality of content items (content items 12A through 12C) supplied from different sources (primary providers, i.e., the content providers 2A through 2C) based on information (access control information 15A through 15C) indicating whether the sales conditions (providing conditions) specified by the primary providers can be changed, and then sells the new package. Such a business method can be easily implemented by an information processing system (FIG. 8) of the present invention, though it is difficult to achieve by a known information processing system. In other words, the information processing system of the present invention can solve the problems unique to the related art.

A description is now given of the information processing system of the present invention corresponding to (or supporting) a model of the business method, such as that shown in FIG. 2.

In the information processing system of this embodiment, as shown in FIG. 8, the content provider servers 101A through 101C managed by the content providers 2A through 2C (FIG. 2), the content aggregator server 103 managed by the content aggregator 21 (FIG. 2), the second service provider 104 managed by the second service provider 51 (FIG. 6), and the user terminal (client) 105 managed by the user 1 (FIG. 2) are connected to each other via the network 102.

The type of network 102 is not particularly restricted, and is, for example, the Internet.

The content provider servers 101A through 101C, the content aggregator server 103, the second service provider server 104, and the user terminal (client) 105 do not have to be connected to the network 102 if they can communicate with each other by another means.

The content providers 2A through 2C are simply referred to as the “content provider 2” unless they have to be individually distinguished. Similarly, the content provider servers 101A through 101C are simply referred to as the “content provider server 101” unless they have to be individually distinguished.

If the content providers 2A through 2C are referred to as the “content provider 2” and if the content provider servers 101A through 101C are referred to as the content provider server 101, the packages 11A through 11C are simply referred to as the “package 11” unless they have to be individually distinguished. For the same reason, the content items 12A through 12C may be referred to as the “content 12”, package metadata 13A through 13C may be referred to as the “package metadata 13”, the content metadata 14A through 14C may be referred to the “content metadata 14”, and the access control information 15A through 15C may be referred to as the “access control information 15”.

A detailed configuration of the content provider server 101 is discussed below with reference to FIG. 9. In this example, the content provider server 101 includes the shop server 111, a metadata database server 112, a settlement server 113, a digital right management (DRM) server 114, a content server 115, and a package generating server 116.

These elements send and receive information to and from other servers or clients (for example, the content aggregator server 103) via the network 102 (FIG. 8).

In response to access from the user terminal (client) 105 via the network 102, the shop server 111 provides navigation information in the form of HTML or BML text indicating how to obtain content to the user terminal 105.

When the model of the business method shown in FIG. 2 is implemented, the user 1 (user terminal 105) obtains the content via the content aggregator 21 (content aggregator server 103) instead of directory obtaining the content from the content provider 2 (content provider server 101). In this case, the above-described processing by the shop server 111 is not essential, and the following processing is executed.

To implement the model of the business method shown in FIG. 2, in response to access and a request from the content aggregator server 103 via the network 102 to send predetermined information, the shop server 111 provides the corresponding information to the content aggregator server 103.

More specifically, for example, the shop server 111 receives a request from the content aggregator server 103 to send metadata corresponding to the package 11 generated by the package generating server 116. In this case, the shop server 111 issues a request to search for metadata corresponding to the package 11 to the metadata database 112.

In response to this search request, the metadata database 112 searches the stored metadata for the metadata corresponding to the package 11, i.e., the content metadata 14, the package metadata 13, and the access control information 15, and provides the searched metadata to the shop server 111. The shop server 111 provides the metadata including the content metadata 14, the package metadata 13, and the access control information 15 to the content aggregator server 103 via the network 102.

The content aggregator server 103 may directly issue a request to send metadata to the metadata database 112 without requesting the shop server 111. In this case, in response to this request, the metadata database 112 reads the stored metadata including the content metadata 14, the package metadata 13, and the access control information 15 and directly provides it to the content aggregator server 103 via the network 102.

When the content provider 2 inputs various items of information by using mainly the shop server 111, that is, when major user interfaces are provided for the shop server 111, the shop server 111 performs processing in response to the information input form the content provider 2.

More specifically, for example, when generating the package 11, the package generating server 116 also generates the corresponding access control information 15. In this case, the content provider 2 may input at least part of the access control information 15, for example, “licensed elements/unlicensed elements”, “type of license”, and “licensing conditions”, which are discussed in detail later with reference to FIG. 14, into the shop server 111. In this case, the shop server 111 provides the input information to the package generating server 116. When inputting information concerning the elements forming the package metadata 13 and the content metadata 14 from the content provider 2, the shop server 111 may provide the input information to the package generating server 116, though it is not shown.

If the content provider 2 directly operates the package generating server 116, the transfer processing of the various information from the shop server 111 to the package generating server 116 is omitted.

The shop server 111 issues a settlement (billing) request for the user 1 or the content aggregator 21 to the settlement server 113. Then, the settlement server 113 communicates with the party designated in the settlement request (user terminal 105 managed by the user 1 or the content aggregator server 103 managed by the content aggregator 21) so as to perform settlement (billing) processing, and then outputs a settlement result to the shop server 111.

When providing a permission 21 to repackage (resell) the package 11 to the content aggregator, the shop server 111 issues a request to authorize the content aggregator 21 to the DRM server 114. Authorization is to provide a right to repackage the package 11, for example, when implementing the model of the business method shown in FIG. 2, i.e., a right to change the elements specified as the licensed elements in the access control information 15 to a secondary provider, such as the content aggregator 21.

The DRM server 114 communicates with a DRM server 124 (FIG. 10) of the content aggregator server 103 and executes DRM processing based on the authorization request from the shop server 111. This DRM processing includes authentication processing to validate whether the content aggregator 21 is an authorized secondary provider (for example, an authorized entity to resell the content provided by the content provider 2) and also includes processing required for copyright management. If the DRM processing has been successfully executed, the DRM server 114 reports to the package generating server 116 that the content aggregator 21 is an authorized entity for the package 11. In contrast, if the DRM processing has not been successfully executed, the DRM server 114 reports to the package generating server 116 that the content aggregator 21 is an unauthorized entity for the package 11.

When the content aggregator server 103 repackages the package 11 provided by the content provider server 101 (regenerates a new package), the storage location of the content contained in the new package is not restricted. For example, the content in the new package may remain in the content server 115 of the content provider server 101. In this embodiment, however, the storage location of the content in the new package is the content aggregator server 103 itself, and more specifically, content server 125 shown in FIG. 10.

In this case, the content server 115 of the content provider server 101 has to provide the package 11 containing the content 12 to the content aggregator server 103.

The provision of the package 11 may be performed in any form, for example, it may be encrypted or not encrypted. However, if the package 11 is provided to the content aggregator server 103 by being encrypted, the DRM server 114 sends a key Kc′ (not shown) required for encrypting the package 11 to the content server 115 when DRM processing for the content aggregator 21 (content aggregator server 103) has succeeded. The DRM server 114 also sends a corresponding key kc′ to the content aggregator server 103 when DRM processing has succeeded.

When the content provider server 101 directly provides (sells) the package 11 to the user 1, the DRM server 114 performs DRM processing on the user terminal 105 of the user 1. In this case, the DRM server 114 executes processing basically similar to that of the DRM server 124 of the content aggregator server 103 shown in FIG. 10. Details of this processing are discussed below.

The content server 115 stores the content 12 as a unit or a package (package 11).

The package generating server 116 generates or obtains at least one content item 12 and also generates or obtains the corresponding content metadata 14, though it is not shown. The package generating server 116 then supplies the content 12 to the content server 115 and supplies the content metadata 14 to the metadata database 112.

The package generating server 116 also generates the package 11 containing at least one content item 12 stored in the content server 115 and also generates the corresponding package metadata 13 and the access control information 15. The package generating server 116 then supplies the package 11 to the content server 115 and also supplies the package metadata 13 and the access control information 15 to the metadata database 112.

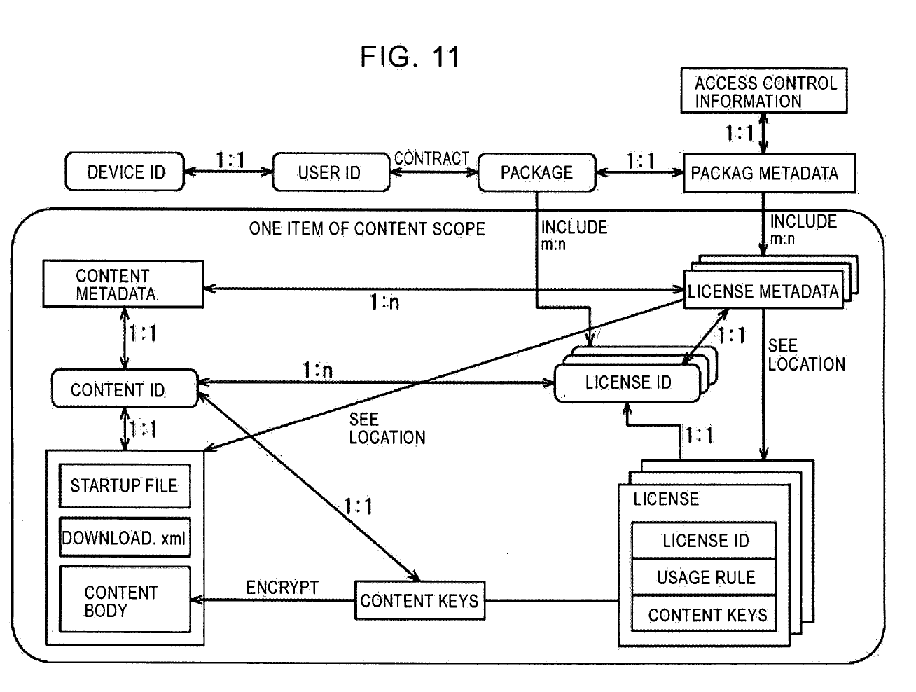

Details (configuration examples) and relationships of the package 11, the content 12, the package metadata 13, the content metadata 14, and the access control information 15 generated by the package generating server 116 are discussed below with reference to FIGS. 11 through 15.

The content server 115 stores the supplied package 11, and in response to a request to send the package 11 from the content aggregator server 103, the content server 115 encrypts the package 11 by using the key Kc supplied from the DRM server 114 if necessary, and supplies the package 11 to the content aggregator server 103.

The package 11 may be distributed from the content server 115 by streaming distribution or downloading distribution (distributing a downloading file). The purpose of distributing the package 11 to the content aggregator 21 is to repackage the package 11 (generate a new package containing the content 12) rather than to play back the content 12. Accordingly, it is preferable that the package 11 be supplied by downloading distribution.

If encryption of the package 11 is not necessary, the content server 115 simply supplies the package 11 to the content aggregator server 103.

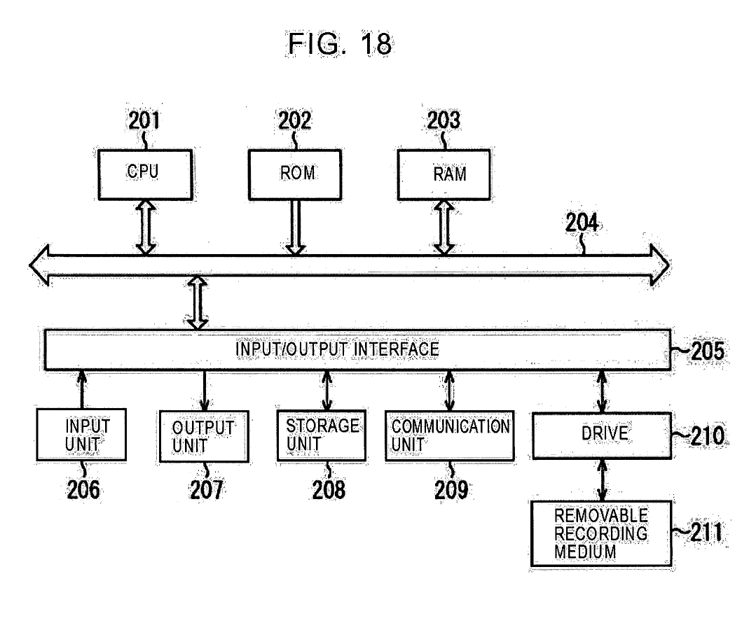

Although the content server 101 is formed of a plurality of servers, as shown in FIG. 9, it may be formed of only one server. The configuration of each server is not particularly restricted as long as it is formed of hardware that can execute the above-described processing, and may be, for example, a personal computer, such as that shown in FIG. 18.

A description is given, with reference to FIG. 10, of a detailed configuration of the content aggregator server 103. In this example, the content aggregator server 103 is formed of the shop server 121, a metadata database 122, a settlement server 123, the DRM server 124, a content server 125, and an access control server 126.

These elements send and receive information to and from other servers or clients, such as the content provider server 101 or the user terminal 105, via the network 102 (FIG. 8).

The shop server 121 issues an instruction to generate a package to be sold by the content aggregator 21 managing the shop server 121, namely, an instruction to repackage the package 11 provided by the content provider server 101 (hereinafter such an instruction is referred to as a “package regenerating instruction), to the access control server 126.

The package 11 provided by the content provider server 101 is hereinafter referred to as an “original package”. The package regenerated by the access control server 126, for example, the package 31, 41, or 61 shown in FIG. 2, 4, or 6, based on the original package 11 is hereinafter referred to as an “updated package”.

After the access control server 126 generates and provides an updated package to the content server 125 in response to a package regenerating instruction (details of such processing are given below), when receiving access from the user terminal 105 via the network 102, the shop server 121 provides navigation information in the form of HTML or BML text indicating how to obtain the updated package to the user terminal 105. For example, the shop server 121 provides navigation information corresponding to the image shown in FIG. 3, 5, or 7 to the user terminal 105.

The image shown in FIG. 3, 5, or 7 indicates that, to generate the navigation information, package metadata, such as the package metadata 32, 42, or 62 shown in FIG. 2, 4, or 6, respectively, of the updated package and content metadata such as the content metadata 14A, 14B, or 14C shown in FIG. 2, 4, or 6, of the content contained in the updated package is required. The metadata of the updated package is collectively referred to as “updated metadata”. That is, to generate navigation information for the updated package, updated metadata is required.

Accordingly, the shop server 121 issues a request to search for the updated metadata to the metadata database 122 if necessary. Then, the metadata database 122 searches the stored metadata (including metadata for the original package) for the updated metadata based on the search request, and provides it to the shop server 121.

Then, when the user 1 presses the purchase button indicated in the image shown in FIG. 3, 5, or 7 and when the user terminal 105 transmits a corresponding signal, the shop server 121 receives the signal and issues a settlement (billing) request to the settlement server 123.

Then, the settlement server 123 communicates with the user terminal 105 to perform settlement (billing) based on the settlement request, and outputs a settlement result to the shop server 121.

The settlement server 123 performs not only the settlement processing for the user terminal 105 (user 1), but also settlement processing in response to the settlement processing performed by the settlement server 113 (FIG. 9) of the content provider server 101 (settlement processing for the content aggregator server 103).

The shop server 121 also requests the DRM server 124 to issue a license for the user 1. Details of the license are given below.

The DRM server 124 communicates with the user terminal 105 to perform DRM processing based on the license issuing request. The DRM processing includes authentication processing to verify whether the user 1 is a licensed user, processing for providing and obtaining a key Kc required for decrypting encrypted data, and processing required for copyright management. If the DRM processing has been successfully performed, the DRM server 124 supplies the key Kc required for encrypting the updated package (content purchased by the user) to the content server 125. If the DRM processing has been successfully performed, the DRM server 124 supplies the corresponding key Kc to the user terminal 105.

In addition to the DRM processing for the user terminal 105 (user 1), the DRM server 124 executes processing in response to the DRM processing performed by the DRM server 114 (FIG. 9) of the content provider server 101.

The content server 125 encrypts the updated package by using the key Kc supplied from the DRM server 124, and supplies the updated package to the user terminal 105 by streaming distribution or downloading distribution.

Upon receiving the updated package from the content aggregator server 103, the user terminal 105 decrypts and plays back the content contained in the updated package by using the key Kc supplied from the DRM server 124. If the updated package is supplied by streaming distribution, the user terminal 105 decrypts the content when receiving it. If the updated package is supplied by downloading distribution, the user terminal 105 temporarily stores the package in a built-in storage unit and then decrypts it when receiving an instruction to play it back from the user 1.

The updated package distributed from the content server 125 to the user terminal 105 is generated by the access control server 126.

More specifically, as stated above, the content provider server 101 sends the original package 11 and the corresponding metadata (hereinafter referred to as the “original metadata”) before generating an updated package. Then, the content aggregator server 103 stores the original package 11 in the content server 125 and stores the original metadata containing the access control information 15 in the metadata database 122.

When all the content items 12 to be contained in the updated package are stored in the content server 125, the access control server 126 obtains the original package 11 containing the target content 12 from the content server 125, and also obtains the original metadata including the access control information 15 corresponding to the original package 11 from the metadata database 122. The access control server 126 then repackages the target content 12 contained in the obtained original package 11 (generates a new updated package containing the target content 12) based on the obtained access control information 15, and generates updated metadata corresponding to the updated package.

More specifically, in the example shown in FIG. 10, the updated package is generated by a package regenerator 131, and the updated metadata is generated by a package metadata regenerator 132.

The updated package generated by the package regenerator 131 is stored in the content server 125, and the updated metadata generated by the package metadata regenerator 132 is stored in the metadata database 122.

Upon completing the above-described series of processing, the access control server 126 issues a corresponding message (hereinafter referred to as a “package regeneration completion message”) to the shop server 121. Upon receiving this message, the shop server 121 performs processing, such as generating the above-described navigation information, on the updated package.

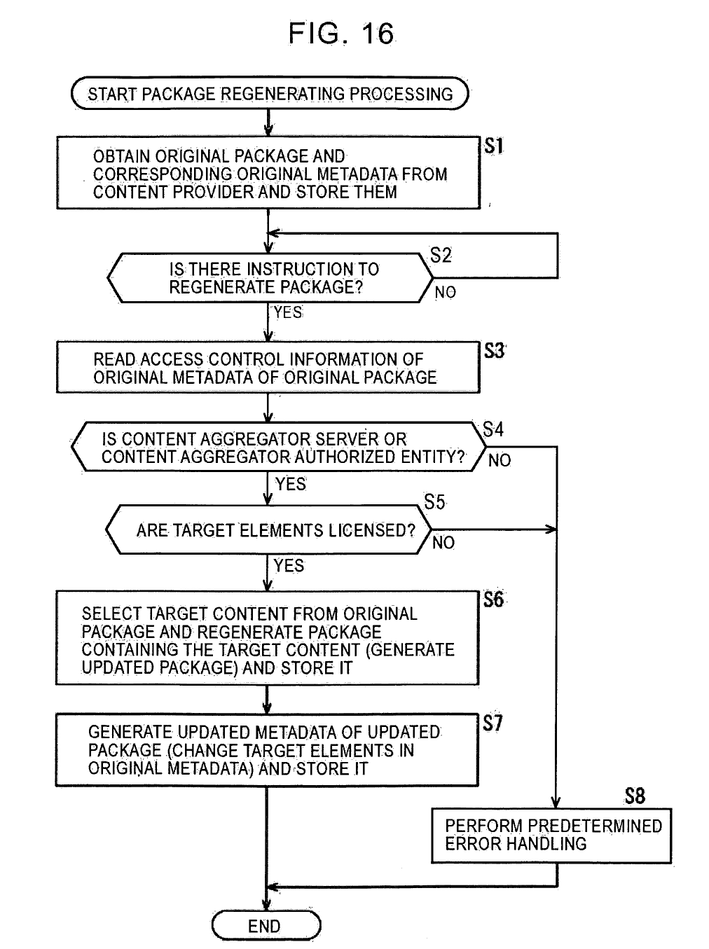

Details (configuration examples) and relationships of the updated package and the updated metadata are given below with reference to FIGS. 11 through 15. Details of generating the updated package and the updated metadata are given below with reference to FIG. 16.

As described above, the content aggregator server 103 generates an updated package containing at least one item of the content 12 contained in the original package 11 provided by the content server 101.

More specifically, in the example shown in FIG. 2, the metadata database 122 obtains the original metadata including the access control information (metadata) 15A, that is, the access control information 15A, the package metadata 13A, and the content metadata 14A, from the content provider server 101A, and stores the original metadata therein.

Similarly, the metadata database 122 obtains the original metadata including the access control information (metadata) 15B, that is, the access control information 15B, the package metadata 13B, and the content metadata 14B, from the content provider server 101B, and stores the original metadata therein.

The package regenerator 131 generates the updated package 31 based on the original metadata stored in the metadata database 122, and stores it in the content server 125.

The package metadata regenerator 132 generate the updated metadata corresponding to the updated package 31, i.e., the package metadata 32, based on the original metadata stored in the metadata database 122. The package metadata regenerator 132 also associates each of the content metadata 14A and 14B with the package metadata 32, and stores the updated metadata (package metadata 32 and the content metadata 14A and 14B) in the metadata database 122.

Although the content aggregator server 103 is formed of a plurality of servers, as shown in FIG. 10, it may be formed of only one server. The configuration of each server is not particularly restricted as long as it is formed of hardware that can execute the above-described processing, and may be, for example, a personal computer, such as that shown in FIG. 18.

The configuration of the second service provider server 104 shown in FIG. 8 is not particularly restricted as long as it is formed of hardware connectable to the network 102 and having functions, such as a function of providing second services, required for implementing the model (FIGS. 6 and 7) of the business method of this embodiment. The second service provider server 104 may be, for example, a personal computer, such as that shown in FIG. 18.

Similarly, the configuration of the user terminal 105 shown in FIG. 8 is not particularly restricted as long as it is formed of hardware connectable to the network 102 and having functions, such as a user interface function of providing the content obtaining operation and a function of providing content and various items of information, required for implementing the model (FIGS. 2 through 7) of the business method of this embodiment. The second service provider server 104 may be, for example, a personal computer, such as that shown in FIG. 18.

The configuration of the information processing system of the present invention that can support the business method shown in FIGS. 2 through 7 has been described.

A description is now given, with reference to FIGS. 11 through 15, of detailed configurations and relationships of a package, corresponding package metadata and access control information, content contained in the package, and corresponding content metadata, which can be used in the models of the business method shown in FIGS. 2 through 7, i.e., in the information processing system shown in FIG. 8.

FIG. 11 illustrates relationships between various items of information, such as settlement, DRM processing, and playback processing. FIG. 11 shows that the device ID and user ID are in one-to-one correspondence. The device ID is the ID assigned to the user terminal 105 (FIG. 8), and the user ID is the ID assigned to the user 1 (FIG. 2) using the user terminal 105. The user terminal 105 and the user 1 can be individually identified by these IDs.

Although the content aggregator 21 has been described as a seller, it can be a user as viewed from the content provider 11. That is, the content provider 11 can assign the user ID and the device ID to the content aggregator 21 or the content aggregator server 103 to verify that it is an authorized secondary provider.

The user 1 having a predetermined user ID contracts with the content aggregator 21, which is the administrator of the content aggregator server 103, to purchase an updated package, for example, the package 31, 41, or 61 shown in FIG. 2, 4, or 6, as a product. The package is associated with package metadata based on one-to-one correspondence. More specifically, the package 31 shown in FIG. 2 corresponds to the package metadata 32, the package 41 shown in FIG. 4 corresponds to the package metadata 42, and the package 61 shown in FIG. 6 corresponds to the package metadata 62.

In the present invention, the package metadata is associated with access control information based on one-to-one correspondence. In FIG. 2, 4, or 6, the association between the package metadata 32, 42, or 62 and the access control information is not shown.

Each package corresponds to at least one content item. More specifically, the package 31 shown in FIG. 2 corresponds to the content items 12A and 12B, the package 41 shown in FIG. 4 corresponds to the content items 12A, 12B, and 12C, and the package 61 shown in FIG. 6 corresponds to the content items 12A, 12B, and 12C.

One content item consists of the content body, Download.xml as a downloading management information file, and a startup file. The content body is the body of the content indicating a television program, a film, or a music piece.

Download.xml is a management information file required when the content is downloading content, and includes a directory and file names. When receiving all the files indicated in the directory, the entire content has been downloaded.

The startup file contains information concerning the distribution type, i.e., whether the content is downloading data or streaming data.

The content is associated with the content ID based on one-to-one correspondence. The content can be uniquely identified by the content ID. The content ID is associated with content metadata based on one-to-one correspondence. More specifically, in the example shown in FIG. 2, a predetermined content ID is assigned to each of the content items 12A and 12B, and the content metadata 14A and 14B are assigned to the corresponding content IDs.

The content metadata includes, as shown in FIG. 12, the content ID (Content_id), title name, genre, and program description. In FIGS. 2, 4, and 6, among the above elements, only the title name is indicated as “title”.

A number n of license IDs (n is an integer of one or greater) are associated with one content ID. Similarly, n license metadata is associated with one content metadata.

The license ID uniquely identifies a license. Each license consists of the license ID, usage rules, and content keys. The content keys include a certain number of keys (corresponding to the key Kc shown in FIG. 10) required for decrypting the content corresponding to the license, and are associated with the content ID based on a one-to-one correspondence.

The license ID is associated with license metadata based on one-to-one correspondence. The license metadata includes, as shown in FIG. 12, the license ID, content ID, content uniform resource locator (URL), license URL, distribution type, content title name, and usage rule text.

The license metadata and the content metadata are associated with each other based on an n:1 correspondence by the number of content IDs.

The content URL of the license metadata indicates the access destination to obtain the content. The license URL indicates the access destination to obtain the license. The distribution type indicates whether the content associated with the license is supplied by stream distribution or downloading distribution.

The package and the license ID are associated with each other based on an m:n basis (m is an integer of one or greater). Similarly, the package metadata and the license metadata correspond to each other based on an m:n basis.

The package metadata includes, as shown in FIG. 12, the package ID/version, sales source information, package type, package information, and license ID list.

More specifically, the package metadata may be formed, as shown in FIG. 13. The package metadata includes major elements satisfying the following seven factors.

The first factor is to describe sales promotion information for selling content consisting of single item. The second factor is to describe sales promotion information for selling a plurality of fixed content items as a pack. The third factor is to describe sales promotion information for allowing the user to select and purchase a certain number of content items from a plurality of content items. The fourth factor is to represent typical forms of billing, in particular, to support variations in the forms of billing. The fifth factor is to allow sellers to indicate discount information with respect to the proper price. The sixth factor is to describe information related to programs or commercials or coupon information for obtaining content. The seventh factor is to describe source information for tracing the route through which sales promotion information has been obtained.

More specifically, in the package metadata shown in FIG. 13, “PackageID/Version” is information for identifying the package.

The “PackageType” indicates whether the type of package is the “Container (pack)” or “Unit”. As stated above, the “unit” means that only one content item is associated with the package, in other words, the package contains only one content item. Conversely, the “Container (pack)” means that two or more content items are associated with the package, in other words, the package contains two or more content items.

The “Container” is further divided into “Set” and “Choice”.

The “Set” means, as discussed with reference to the package metadata 32 shown in FIG. 2 or the image shown in FIG. 3, that the content items contained in (associated with) a package is fixed, and billing is conducted, assuming that all the content items are purchased.

The “Set” is further divided into “Fixed” and “Variable”. The “Fixed” means that the content in a package is fixed when the user purchases the package, such as a DVD resale package for content which was broadcast before. Conversely, the “Variable” means that the content (subscription form) is not fixed when the user purchases the package, such as sport program broadcast series.

In contrast to the “Set”, “Choice” means, as discussed with reference to the package metadata 42 shown in FIG. 4 or the image shown in FIG. 5, that certain content items can be selected by the user among the content items contained in a package and that billing is conducted according to the number of selected content items.

The “PackageType” may also include “service association” described with reference to FIG. 6.

The “PackageName/Description/Genre” indicates the name of the package, specific descriptions of the package, and the genre of the package.

The “Supplier (sales source information)” indicates information concerning the package seller. More specifically, in the “Supplier (sales source information)” of the package metadata 32, 42, or 62 shown in FIG. 2, 4, or 6, respectively, the information concerning the content aggregator 21 is indicated.

The “Promotion (promotion information)” indicates sales promotion information for the package. More specifically, in the “Promotion (promotion information)” of the package metadata 32 shown in FIG. 2, information, such as “summer vacation limited sales”, is indicated, as in the image shown in FIG. 3.

The “PackageRef/HowRelated (package reference/upper/related)” indicates the package ID of the upper- or related-package of the package in this package metadata.

The “TargetID (description identifier)” represents the destination for positional information (broadcasting schedules or addresses) concerning instances, such as the package or content contained in the package.

The “Price (billing information)” includes the contract type, price, usage-mode dictionary reference, etc. More specifically, the “Price (billing information)” includes “ContractType (standard/discount), “ActionType (playback/output usage-mode dictionary reference)”, “FixedPrice (fixed price/unit regardless of the amount of use), “VariablePrice (unit dependent on the amount of use) “Currency (currency unit)”, and “PriceValidPeriodFrom/To (effective period)”.

The “ContractType” indicates whether the type of price set for the package is “Standard” or “Discount”. The “Standard” means that the total cost (proper price) of the individual prices for the content items contained in the package is set as the price of the package. The “Discount” means that a discount price, which is less expensive than the price set as the “Standard”, is set as the price of the package.

The “ActionType (playback/output usage-mode dictionary reference)” indicates the usage mode of the package (content). For example, if the “ActionType (playback/output usage-mode dictionary reference)” indicates “when recording (copying) the content into a removable recording medium”, the user is charged every time the content contained in the package is recorded in a removable recording medium.

In the “FixedPrice (fixed price/unit regardless of the amount of use), the fixed price/unit regardless of how much the content is used is indicated. The basic unit for the fixed price is designated in the “UOM (unit of fixed price)”. More specifically, for example, “500/month”, is indicated in the “FixedPrice”.

Conversely, in the “VariablePrice (unit dependent on the amount of use)”, the price/unit dependent on the amount by the user has used the content (so-called “metered rate”) is designated. The basic unit for the variable price is designated in the “UOM (unit of fixed price)”. More specifically, for example, “100/time”, is indicated in the “VariablePrice”.

The “Currency (currency unit)” represents the currency unit for the numeric value indicated in the “FixedPrice” or “VariablePrice”. More specifically, if “¥(Yen)” is indicated in the “Currency (currency unit)”, the above-described information “500/month” means that the user is charged for 500 yen per month regardless of how many times the user uses the content, and the above-described information “100/time” means that the user is charged for 100 yen every time he/she uses the content.

The “PriceValidPeriodFrom/To (effective period)” indicates the effective period during which the user can use the package when he/she purchases the package under the above-described price conditions.

In the examples shown in FIGS. 2, 4, and 6, the “PriceValidPeriodFrom/To (effective period)” is simply represented by the “viewing period”, and the items of information in the “Price (billing information)” other than the “PriceValidPeriodFrom/To (effective period)” is simply represented by the “price”.

If the contract type of the upper package of the package in this package metadata is “Discount”, “DiscountPrice (discount purchase/sales conditions/price)” (containing information indicated at the right side of FIG. 13) is also contained in the package metadata. The configuration of this information is similar to that of the above-described “Price (billing information)”.

The “RMPInfo/Ref (RMP system dependence information/reference)” indicates information dependent on a rights management & protection (RMP) system or a reference destination of the information. The RMP is a technique for handling management protection of broadcasting content.

The “MaxNumOfItems (maximum number of elements)” indicates the number of elements (content items) that can be contained in a package when the package type of package is “Container (pack)”.

The “Origin (source information)” designates the source (primary provider) of each item of content contained in the package. More specifically, the information concerning the content provider 2A is indicated in the “Origin (source information)” in the package metadata 13A (FIG. 2). In this case, the above-described “Supplier (sales source information)” coincides with the “Origin (source information)”. In the “Origin (source information) in the package metadata 32 (FIG. 2), the information concerning the content provider 2A and information concerning the content provider 2B is indicated.

In the “Coupon”, coupon information, for example, “if you buy one content, you can get another content free”, “consumption tax refund” is indicated.

In the “license ID list”, the license ID contained in the package is designated. That is, the package metadata is associated with the license metadata corresponding to the license ID.

The configuration of the package metadata to which the present invention is applied is not restricted to the example shown in FIG. 13. The package metadata may be configured in any manner as long as it contains at least one item designated as a licensed element in the access control information.

As stated above, one access control information (metadata) is associated with one package metadata. An example of the configuration of the access control information to which the present invention is applied is shown in FIG. 14.

In the access control information shown in FIG. 14, in the “target package identifier”, the package ID of the package associated with the access control information is indicated.

In the “target content identifier”, information concerning the content items licensed by the primary provider, i.e., the content providers 2A through 2C shown in FIG. 2, among the content items in the package is indicated. For example, the content ID (Content_id) shown in FIG. 12 or the target description identifier (TargetID) shown in FIG. 13 is indicated.

In the “authorized entity (ProviderName)/unauthorized entity (UnproviderName)”, information concerning an authorized entity (ProviderName) and information concerning an unauthorized entity (UnproviderName) set by the primary provider for the package corresponding to the access control information are indicated.

That is, for the entity authorized as an authenticated secondary provider (for example, the content aggregator 21) for the target package (content) by the primary provider, the name or ID of the authenticated secondary provider is indicated in the “authorized entity/unauthorized entity”.

On the other hand, for the entity which is not authorized as an authenticated secondary provider for the target package (content) by the primary provider, the name or ID of the unauthenticated secondary provider is indicated in the “authorized entity/unauthorized entity”.

The “licensed element (ElementName)/unlicensed element (UnelementName) indicates whether each element (for example, “Supplier (sales source information)”) of the package associated with the access control information is a licensed element or an unlicensed element.

FIG. 15 illustrates an example of the “licensed elements (ElementName)/unlicensed elements (UnelementName) when the access control information shown in FIG. 14 is associated with the package metadata shown in FIG. 13.

In FIG. 15, the licensed element candidates are elements that can be changed (the above-described variable portions) among the elements forming the package metadata, that is, the elements that can be changed by a secondary provider by permission of the primary provider.

At the left of the licensed element candidates in FIG. 15, the circles indicate that the primary provider has permitted a secondary provider to change the corresponding elements, and the cross (x) indicate that the primary provider has prohibited the secondary provider from changing the corresponding elements.

In this case, the elements with the circles, i.e., the “PackageType”, “Supplier (sales source information)”, “PackageRef/HowRelated (package reference/upper/related)”, and “Price (billing information) (including discount billing information)” are indicated in the “licensed elements (ElementName)/unlicensed elements (UnelementName)” as the licensed elements (see the top right of FIG. 15).

In contrast, the elements with the cross (x), i.e., the “PackageName/Description/Genre”, “Promotion (promotion information)”, “RMPInfo/Ref” (RMP system dependence/reference), “Origin (source information)”, and “Coupon”, are indicated in the “licensed elements (ElementName)/unlicensed elements (UnelementName)” as the unlicensed elements (see the bottom right of FIG. 15).

The elements forming the package metadata shown in FIG. 13 include elements that are not licensed element candidates, i.e., “packageID/Version” and “TargetID (target description identifier)”, elements fixed as invariable elements regardless of with/without the permission of the primary provider. Such fixed elements are also indicated in the “licensed elements (ElementName)/unlicensed elements (UnelementName)” as the unlicensed elements (see the bottom right of FIG. 15).

The “license ID list” is formed by the secondary provider (content aggregator 21) and is excluded from the “authorized entity (ProviderName)/unauthorized entity (UnproviderName)”.

Referring back to FIG. 14, the “type of license (create or modify)” indicates the type of license (operation) given to the elements in the “authorized entity (ProviderName)/unauthorized entity (UnproviderName)”. The type of license (operation) is not particularly restricted, and it is classified into “create (new)” and “modify” in the example shown in FIG. 14. The same type of license (operation) may be set in all the licensed elements, or different types of licenses may be set in the individual licensed elements.

The “licensing conditions” indicate conditions under which the primary provider permits the secondary provider to change licensed elements. The types of conditions are not particularly restricted. In the example shown in FIG. 14, information, such as “fee for the information changing operation to be paid to the origin (source) of the licensed elements” and “type of information to be provided to the origin (number of sales items, target user information, etc.), is indicated.

The configuration of the access control information to which the present invention is applied is not restricted to the example shown in FIG. 14. The access control information may be configured in any manner as long as it includes at least information concerning the licensed elements among the elements forming the corresponding package metadata.

A description is now given, with reference to the flowchart of FIG. 16, of processing for repackaging an original package, i.e., processing for generating an updated package and updated metadata (hereinafter referred to as “package regenerating processing”), by the content aggregator server 103 shown in FIG. 10, by referring to the access control information, such as that shown in FIG. 14.

In step S1, the content aggregator server 103 obtains the original package 11 and the corresponding original metadata (including the access control information 15) from the content provider 101 and stores them. More specifically, the original metadata is stored in the metadata database 122, and the original package 11 is stored in the content server 125.

In the example shown in FIG. 2, from the content provider 2A (content provider 101A shown in FIG. 8), the access control information 15A, the package metadata 13A, and the content metadata 14A are supplied as the original metadata, and the package 11A including the content 12A is supplied as the original package.

From the content provider 2B (content provider 101B shown in FIG. 8), the access control information 15B, the package metadata 13B, and the content metadata 14B are supplied as the original metadata, and the package 11B including the content 12B is supplied as the original package.

From the content provider 2C (content provider 101C shown in FIG. 8), the access control information 15C, the package metadata 13C, and the content metadata 14C are supplied as the original metadata, and the package 11C including the content 12C is supplied as the original package.

Step S1 is performed at any time as long as it is performed before the shop server 121 of the content aggregator server 103 instructs the access control server 126 to regenerate a package.

In step S2, the access control server 126 of the content aggregator server 103 determines whether an instruction to regenerate a package has been given from the shop server 121.

If the result of step S2 is NO, the process returns to step S2, and repeats step S2 until it is determined that an instruction to regenerate a package has been given. That is, the access control server 126 always monitors an instruction from the shop server 121.

It is now assumed, for example, that the content aggregator 21 (FIG. 2) inputs an instruction to regenerate a package containing the content items 12A and 12B into the shop server 121.

In this case, in response to the instruction, the shop server 121 issues a package regenerating instruction to the access control server 126.

Then, the access control server 126 determines in step S2 that an instruction to regenerate a package has been given, and then reads the access control information 15 of the original metadata of the original package 11 from the metadata database 122 in step S3.

More specifically, in the example shown in FIG. 2, the access control information 15A, 15B, and 15C are read.

In step S4, the access control server 126 determines by referring to the “authorized entity (ProviderName)/unauthorized entity (UnproviderName)” (FIG. 14) of the read access control information 15 whether the content aggregator server 103 or the content aggregator 21 (FIG. 2) is an authorized entity.

In the example shown in FIG. 2, a package containing the content items 12A and 12B is to be generated.

In this case, if, in the “authorized entity (ProviderName)/unauthorized entity (UnproviderName)” of at least one of the access control information 15A and 15B, the content aggregator 21 (or content aggregator server 103) is not indicated as an authorized entity, or if the content aggregator 21 (or content aggregator server 103) is indicated as an unauthorized entity, it is determined in step S4 that the content aggregator 21 is not an authorized entity. Then, in step S8, the access control server 126 performs predetermined error handling, and the package regenerating processing is terminated.

In contrast, if, in the “authorized entity (ProviderName)/unauthorized entity (UnproviderName)” of both the access control information 15A and 15B, the content aggregator 21 (or content aggregator server 103) is indicated as an authorized entity, it is determined in step S4 that the content aggregator 21 is an authorized entity. The process then proceeds to step S5.

In step S5, the access control server 126 determines whether target elements (package information) in the original metadata are licensed elements.

In the example shown in FIG. 2, the “type”, “viewing period”, and “price” are licensed elements (package information).

In this case, if a package containing all the content items 12A, 12B, and 12C (not shown in FIG. 2) is to be generated, the access control information 15C corresponding to the package metadata 13C shows that the “type (change)” and the “viewing period (change)” are unlicensed elements. Accordingly, the access control server 126 determines in step S5 that at least part of the target elements of the original metadata is not a licensed element. Thus, in step S8, the access control server 126 performs predetermined error handling, and the package regenerating processing is terminated.

Conversely, if, in the example shown in FIG. 2, a package (package 31) containing the content items 12A and 12B is to be generated, the access control information 15A corresponding to the package metadata 13A and the access control information 15B corresponding to the package metadata 13B both indicate that all the target elements (“type”, “viewing period”, and “price”) are licensed elements. In this case, the access control server 126 determines in step S5 that the target elements (package information) of the original metadata are licensed elements, and proceeds to step S6.

In step S6, the package regenerator 131 of the access control server 126 selects the target content 12 from the content items 12 contained in the original package 11, regenerates a package containing the target content 12 (generates an updated package), and stores the generated package in the content server 125.

More specifically, in the example shown in FIG. 2, the package regenerator 131 selects the content 12A contained in the package 11A and the content 12B contained in the package 11B as target content items, regenerates the package 31 containing the target content items (generates the updated package 31), and stores the package 31 in the content server 125.

Then, in step S7, the package metadata regenerator 132 of the access control server 126 generates updated metadata of the updated package (changes the target elements in the original metadata based on the access control information), and stores the updated metadata in the metadata database 122.

More specifically, in the example shown in FIG. 2, the package metadata regenerator 132 generates the updated metadata 32 of the updated package 31, i.e., changes the “type” into “fixed/pack”, the “viewing period” into “one month”, and “price” into “1000 yen”, and stores the updated metadata 32. The package regenerating processing is then completed.

The information processing system (information processing apparatus) of the present invention that can support the business method models shown in FIGS. 2 through 7 has been described with reference to FIGS. 8 through 16.

The information processing system (information processing apparatus) of the present invention can support various models of the business method other the models shown in FIGS. 2 through 7.

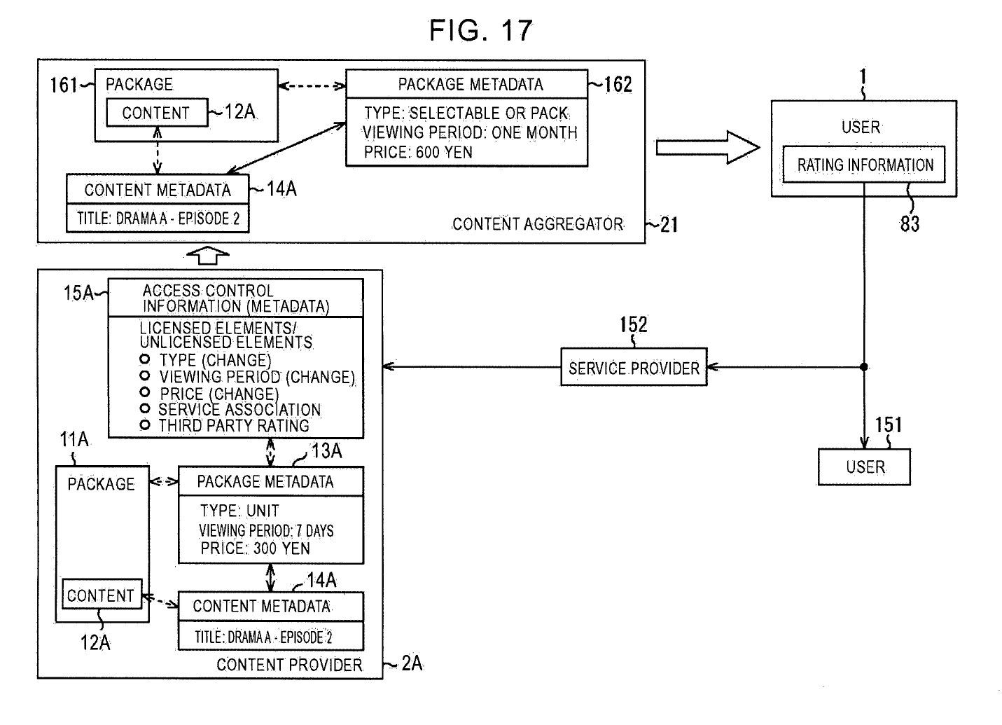

An example of such a model is shown in FIG. 17. More specifically, FIG. 17 illustrates the configuration of a model of the business method supported by the information processing system of the present invention. In FIG. 17, elements corresponding to those in FIG. 2 are designated with like reference numerals.

As in the business method shown in FIG. 2, in FIG. 17, a certain number of users (two users 1 and 151 in FIG. 7), a certain number of content providers (one content provider 2A in FIG. 7), and a certain number of content aggregators (one content aggregator 21 in FIG. 7) can be participated.

Additionally, a service provider 152 is also participated in this business method model. The service provider 152 may be considered as a second service provider for providing a service different from the service provided by the second service provider 51 shown in FIG. 6.

As stated above, the user 1 controls the user terminal (client) 105, such as the one shown in FIG. 8, which can be connected to a network 102, and obtains (purchases) content by using this user terminal 105.

When using the content, the user 1 rates the content, generates rating information 83 consisting of the result of rating (so-called “recommendation information”) and information concerning the user 1 himself/herself (so-called “introducer information”), and supplies the rating information 83 to another user 151 and the service provider 152.

The rating is a process for assigning values to content based on certain obligations or criteria. There are two types of ratings, i.e., self-rating and third-party rating. The self-rating means that a content provider rates the content provided by the content provider. That is, in the example shown in FIG. 17, the content provider 2A rates (evaluates) the content 12A. The third-party rating means that a third party rates content provided by another content provider. That is, in the example shown in FIG. 17, the user 1 rates the content 12A.

The user 151 manages a terminal (not shown) having functions and configuration similar to those of the user terminal (client) 105, and considers, for example, whether to purchase the content 12A by using this terminal based on the rating information 83 supplied from the user 1.

The service provider 152 manages a server (not shown) having functions and configuration similar to those of the second service provider server 104 (FIG. 8) that can be connected to the network 102, collects and analyzes rating information supplied from many users, for example, the rating information 83 supplied form the user 1, and provides the analysis results or various services based on the analysis results. Although in the example shown in FIG. 17 the service provider 152 provides services to the content provider 2A, it may provide services to the user 1 or 151, the content aggregator 21, or another entity.

The third-party rating presents the following three problems as viewed from the content provider (content provider 2A in the example shown in FIG. 17). The first problem is that the content provider may not know that materials provided by the content provider have been rated or the rating results. The second problem is that the rating results may not be appropriate. The third problem is that an arbitration procedure cannot be taken when the content provider does not agree with the third party rating.

To solve these problems, the content provider 2A can add, as shown in FIG. 17, the third-party rating licensing to the access control information 15A.

If, for example, the third-party rating is indicated as a licensed element, as indicated by the circle in FIG. 17, it means that the content provider 2A allows the third-party rating for the package 11A (content 12A).

In this case, when generating an updated package 161 containing the content 12A of the package 11A, the content aggregator 21 can add information required for allowing the user 1 to perform the third-party rating to updated package metadata 162, though it is not shown.

The user 1 who purchased (obtained) the package 161 can rate the package 161, and provides the rating results to the user 151 or the service provider 152 as the rating information 83.

Conversely, if the third-party rating is indicated as an unlicensed element, though it is not shown, it means that the content provider 2A prohibits the third-party rating for the package 11.

In this case, when generating the updated package 161 containing the content 12A of the package 11A, the content aggregator 21 cannot add information required for allowing the user 1 to perform the third party rating to the updated package metadata 162, though it is not shown.

Accordingly, the user 1 who purchased the package 161 cannot rate the package 161.

In the example shown in FIG. 17, information indicating whether to allow the third-party rating is indicated as a licensed element or an unlicensed element. Alternatively, it may be handled as a licensing condition (FIG. 14).

A summary of the above-described business method model that can be supported by the information processing system (information processing apparatus) of the present invention is as follows. In this model, a content provider assigns content and rights to change the metadata of the content to a content aggregator. The content aggregator updates part of the metadata (licensed elements) so as to provide a new value/creation to general users, and then returns profit obtained by the provision of the new value/creation to the original owner of the metadata (content provider itself).

The information processing system (information processing apparatus) of the present invention can also support a business method model for adding services concerning the quality (QoS) of a network or a provider, such as the image quality or the communication quality. In this case, service information concerning the quality (QoS) is contained as elements forming metadata, and such service information can be classified into licensed elements and unlicensed elements.

Similarly, the information processing system (information processing apparatus) of the present invention can also support a business method model that can provide recommendations of codec or conversion services (cross encoding services) that match client terminals, such as television receivers, video cassette tape recorders, set-top boxes, and personal computers. In this case, information concerning the recommendations or conversion services of codec is contained as elements forming metadata, and such information can be classified into licensed elements and unlicensed elements.

As discussed above, the information processing system (information processing apparatus) of the present invention can support business method models for providing various services. In this case, information concerning the corresponding services is contained in metadata, and access control information including information concerning the rights or licenses that can be defined as a class is generated (access control information is added to the metadata. In other words, information concerning services provided by the content defined in this specification is contained in metadata (if metadata does not exist, metadata including such information is generated), and access control information including information concerning the rights or licenses (providing conditions) is generated.

From the viewpoint of metadata, in the information processing system (information processing apparatus) of the present invention, it is necessary that metadata (structure) simply contain a descriptor (fixed portion) for uniquely identifying the corresponding content or content group (package) and a variable portion that can be changed later by being updated or added. As stated above, the content in a broad sense also contains commercials.

Information concerning the variable portion is not particularly limited, and may contain various types of information, such as the content owner, supply source, service provider, accompanying information indicating the rights for the user, effective period, price, how to obtain content, and how to play back content.

Information contained in the variable portion varies depending on the agent that changes licensed elements. More specifically, for a sales agent, information contained in the variable portion can be sales promotion information. For a settlement (billing) agent, such information may be the form of billing. If the content aggregator is an agent, such information may be content production, sales, billing, related services, etc. In this case, the content aggregator can combine a plurality of content items to generate an updated package which is different from the original package.

The information defining the variable portion and the licensed elements is indicated in the access control information, which is independent of the package metadata. However, the above-described information may be formed in various manners; for example, such information can be contained in part of the package metadata.

The above-described series of processing may be executed by hardware or software. In this case, the servers and the client shown in FIG. 8, that is, each of the content provider servers 101A, 101B, and 101C, the content aggregator server 103, the second service provider server 104, and the user terminal (client) 105 can be formed as at least one personal computer, such as that shown in FIG. 18.

In FIG. 18, a central processing unit (CPU) 201 executes various types of processing according to a program stored in a read only memory (ROM) 202 or a program loaded into a random access memory (RAM) 203 from a storage unit 208. In the RAM 203, data required for executing various types of processing by the CPU 201 is also stored.

The CPU 201, the ROM 202, and the RAM 203 are connected to each other via a bus 204. An input/output interface 205 is also connected to the bus 204.

The input/output interface 205 is connected to an input unit 206 including a keyboard and a mouse, an output unit 207 including a cathode ray tube (CRT) or liquid crystal display (LCD) and a speaker, the storage unit 208 including a hard disk, and a communication unit 209 including a modem. The communication unit 209 performs communication processing via the network 2 (FIG. 8), such as the Internet.

A drive 210 is connected to the input/output interface 205, and a removable recording medium 211, such as a magnetic disk, an optical disc, a magneto-optical disk, or a semiconductor memory, is installed in the drive 210 when necessary, and a computer program read from the removable recording medium 211 is installed into the storage unit 208 when necessary.

When software is used to execute the above-described series of processing, a corresponding software program is installed from a recording medium or via a network.

This recording medium may be formed of the removable recording medium 211 storing the program therein, such as a magnetic disk (including a floppy disk), an optical disc (compact disc read only memory (CD-ROM) and a digital versatile disk (DVD)), a magneto-optical disk (mini-disk (MD)), or a semiconductor memory, which is distributed for providing the program to the user separately from the apparatus. Alternatively, the recording medium may be formed of the ROM 202 or a hard disk contained in the storage unit 208 storing the program therein, which is distributed to the user while being contained in the apparatus.

In this specification, steps forming the program recorded in the recording medium may be executed in chronological order defined in the specification. Alternatively, they may be executed concurrently or individually.

In this specification, the system indicates an entire apparatus consisting of a plurality of devices.

1. An information processing apparatus for generating a second package containing at least one content item selected from content items contained in a first package provided by a second information processing apparatus, comprising:
storage means for obtaining first metadata corresponding to the first package from the second information processing apparatus and storing the obtained first metadata therein, the first metadata including control information concerning conditions for generating the second package;
package generating means for generating the second package containing said at least one content item selected from the content items contained in the first package based on the control information contained in the first metadata stored in the storage means; and
metadata generating means for generating second metadata corresponding to the second package generated or to be generated by the package generating means based on the control information.

2. The information processing apparatus according to claim 1, wherein the control information includes information concerning licensed elements that are allowed to be changed among elements forming the first metadata.

3. The information processing apparatus according to claim 2, wherein the control information further includes information concerning the type of operation to change each of the licensed elements.

4. The information processing apparatus according to claim 2, wherein the control information further includes information concerning a licensing condition for changing each of the licensed elements.

5. The information processing apparatus according to claim 2, wherein the control information further includes information concerning a device or an administrator for the device that is authorized to change each of the licensed elements.

6. The information processing apparatus according to claim 1, wherein the control information further includes information concerning content items that are allowed to be contained in the second package and selected from the content items of the first package.

7. An information processing method for an information processing apparatus for generating a second package containing at least one content item selected from content items contained in a first package provided by a second information processing apparatus, the information processing method comprising:
a storage step of obtaining first metadata corresponding to the first package from the second information processing apparatus and storing the obtained first metadata therein, the first metadata including control information concerning conditions for generating the second package;
a package generating step of generating the second package containing said at least one content item selected from the content items contained in the first package based on the control information contained in the first metadata stored in the storage step; and
a metadata generating step of generating second metadata corresponding to the second package generated or to be generated in the package generating step based on the control information.

8. A program for allowing a computer to execute processing for generating a second package containing at least one content item selected from content items contained in a first package provided by a second information processing apparatus, the program comprising:
a storage step of obtaining first metadata corresponding to the first package from the second information processing apparatus and storing the obtained first metadata therein, the first metadata including control information concerning conditions for generating the second package;
a package generating step of generating the second package containing said at least one content item selected from the content items contained in the first package based on the control information contained in the first metadata stored in the storage step; and
a metadata generating step of generating second metadata corresponding to the second package generated or to be generated in the package generating step based on the control information.
